(19) United States
(12) Patent Application Publication
(10) Pub. No.: US 2017/0084210 A1
(43) Pub. Date: Mar. 23, 2017

(54) DECORATIVE ILLUMINATION INK JET RECORDING MATERIAL, DECORATIVE ILLUMINATION IMAGE, METHOD OF FORMING THE SAME, AND DECORATIVE ILLUMINATION SIGNBOARD

(71) Applicant: FUJIFILM CORPORATION, Tokyo (JP)

(72) Inventors: Toshiaki HAYASHI, Fujinomiya-shi (JP); Naoki KOITO, Fujinomiya-shi (JP)

(21) Appl. No.: 15/367,183

(22) Filed: Dec. 2, 2016

Related U.S. Application Data
(63) Continuation of application No. PCT/JP2015/071566, filed on Jul. 29, 2015.

(30) Foreign Application Priority Data
Jul. 31, 2014 (JP) 2014-157189

(51) Int. Cl. G09F 13/00; G09F 13/04; G09F 13/16; B41M 5/50; B41J 11/00

(52) U.S. Cl. CPC G09F 13/00; B41M 5/502; B41J 11/002; G09F 13/16; G09F 13/04

(57) ABSTRACT

To provide a decorative illumination ink jet recording material including a resin base, an ink accepting layer that contains at least white particles and is disposed on one surface of the resin base, and a protective layer that contains at least transparent particles and is disposed on the other surface of the resin base, a decorative illumination image, a method of forming the decorative illumination image, and a decorative illumination signboard.

### CROSS-REFERENCE TO RELATED APPLICATIONS

This application is a continuation application of International Application No. PCT/JP2015/071566, filed Jul. 29, 2015, the disclosure of which is incorporated herein by reference in its entirety. Further, this application claims priority from Japanese Patent Application No. 2014-157189, filed Jul. 31, 2014, the disclosure of which is incorporated herein by reference in its entirety.

### BACKGROUND OF THE INVENTION

1. Field of the Invention

The present disclosure relates to a decorative illumination ink jet recording material, a decorative illumination image, a method of forming the decorative illumination image, and a decorative illumination signboard.

2. Description of the Related Art

In recent years, ink jet systems that discharge an ink composition in the form of droplets from an ink discharge port have been put to wide practical use since these are small and inexpensive and can form an image on a recording medium in a non-contact manner. Among the ink jet systems, piezo ink jet systems that discharge an ink using deformation of a piezoelectric element, and thermal ink jet systems that discharge an ink composition in a dropwise manner using a boiling phenomenon of the ink composition that is caused by thermal energy have characteristics such as high resolution and excellent high-speed printing properties.

Recently, ink jet printers have been used not only to print photographs or documents for home or office use, but also to produce large advertisements to be attached to decorative illumination signboards, store windows, station passages, or walls of buildings. For example, many sheets for a decorative illumination signboard produced using an ink jet printer are provided for various places.

Regarding such a sheet for decorative illumination, in a case where sunlight enters during daytime, the image is displayed by reflection or diffusion of the light by a component such as a pigment in the image, and in a case where light from a light source (a so-called backlight) of a signboard or the like enters during the night, the image is displayed by diffusing transmitted light passing through the sheet and emphasizing the image in accordance with the degree of transmission of the light.

As a technology related to the above description, an ink jet recording material in which an ink accepting layer containing a specific amount of a titanium oxide mixed therein is provided on a substrate is disclosed, and this technology shows that a high-density print image is provided with any one of reflected light and transmitted light (for example, see JP2004-167706A).

In addition, a decorative illumination recording material having an ink accepting layer containing a porous pigment such as wet silica, magnesium chloride, and an aqueous polyurethane resin is disclosed (for example, see JP2002-11942A).

A recording sheet in which a transparent image receiving layer containing fine crosslinked polymer particles is provided on one surface of a transparent support and a white coating layer containing a white pigment is provided on the other surface of the transparent support in order to achieve a high gloss and to relieve graininess in an ink jet recording image is disclosed (for example, see JP1998-207100A (JP-H10-207100A)).

### SUMMARY OF THE INVENTION

Since the above-described display material for decorative illumination displays an image with reflected light of sunlight or illumination light and transmitted light of an internal light source such as a backlight, a clear image is developed regardless of the reflected light and the transmitted light, and in a case where the image is displayed with transmitted light, it is required not to show an image (also referred to as a light source image or a lamp image) of the light source itself such as a backlight.

However, the related arts disclosed in, for example, JP2004-167706A and JP2002-11942A, have a problem in that regarding an image that is visually confirmed by light (transmitted light) entering and passing from an internal light source (a so-called backlight) disposed on a side opposite to a side on which the image is visually confirmed, a clear transmission image is not displayed since a light source image (lamp image) is shown in the image.

Particularly, in a case of use for decorative illumination such as a decorative illumination signboard, a visible image derived from a light source (a light-emitting diode (LED), a fluorescent tube, or the like) emitting light from the side opposite to the side on which the image is visually confirmed, specifically, a light source image that is shown by shade of light impairs the appearance of the product, and thus causes significant product quality deterioration. Currently, according to a recording sheet described in JP1998-207100A (JP-H10-207100A), technologies capable of deriving the clearness of an image and preventing a light source image are not yet established.

Embodiments of the invention are contrived in view of the above-described problems. An object thereof is to provide a decorative illumination ink jet recording material in which a light source image shown in a case where transmitted light enters is unlikely to be visually confirmed, and an image that is clearly developed with any one of reflected light (sunlight, indoor lighting, or the like) and transmitted light (backlight or the like) is obtained, a decorative illumination image that is clear and in which a light source image is unlikely to be visually confirmed, a method of forming the decorative illumination image, and a decorative illumination signboard in which a light source image is unlikely to be visually confirmed and a clear decorative illumination image is displayed, and a task thereof is to achieve this object.

Specific means for achieving the object includes the following embodiments.

<1> A decorative illumination ink jet recording material comprising a resin base, an ink accepting layer that contains at least white particles and is disposed on one surface of the resin base, and a protective layer that contains at least transparent particles and is disposed on the other surface (that is, a surface of the resin base on a side opposite to the side on which the ink accepting layer is disposed) of the resin base.

<2> The decorative illumination ink jet recording material according to <1>, in which the ink accepting layer comprises a first ink accepting layer and a second ink accepting layer in order from a side close to the resin base.

<3> The decorative illumination ink jet recording material according to <2>, in which among the first ink accepting layer and the second ink accepting layer, at least the first ink accepting layer contains white particles.

<4> The decorative illumination ink jet recording material according to <3>, in which among the first ink accepting layer and the second ink accepting layer, at least the second ink accepting layer contains transparent particles.

<5> The decorative illumination ink jet recording material according to <1>, in which the ink accepting layer further contains transparent particles.

<6> The decorative illumination ink jet recording material according to any one of <2> to <4>, in which the first ink accepting layer further contains transparent particles.

<7> The decorative illumination ink jet recording material according to any one of <1> to <6>, in which the protective layer comprises a first protective layer and a second protective layer in order from the side close to the resin base.

<8> The decorative illumination ink jet recording material according to <7>, in which among the first protective layer and the second protective layer, at least the first protective layer contains white particles, and at least the second protective layer contains transparent particles.

<9> The decorative illumination ink jet recording material according to any one of <1> to <8>, in which the white particles include titanium dioxide.

<10> The decorative illumination ink jet recording material according to any one of <1> to <9>, in which the transparent particles include particles of crosslinked polymethylmethacrylate.

<11> The decorative illumination ink jet recording material according to any one of <1> to <10>, in which the content of the white particles is 1.0 g/m² to 10.0 g/m².

<12> The decorative illumination ink jet recording material according to any one of <1> to <11>, in which the average primary particle diameter of the transparent particles is in a range of 0.1 μm to 1.5 μm

<13> A method of forming a decorative illumination image comprising discharging a radiation-curable ink composition to form an image by an ink jet method on the decorative illumination ink jet recording material according to any one of <1> to <12>, and curing the radiation-curable ink composition by irradiating the discharged radiation-curable ink composition with radiation.

<14> A decorative illumination image that is formed by the method of forming a decorative illumination image according to <13>.

<15> A decorative illumination signboard comprising a light source and the decorative illumination image according to <14>.

According to the embodiment of the invention, a decorative illumination ink jet recording material in which a light source image shown in a case where transmitted light enters is unlikely to be visually confirmed, and an image that is clearly developed with any one of reflected light (sunlight, indoor lighting, or the like) and transmitted light (backlight or the like) is obtained is provided.

According to the embodiment of the invention, a decorative illumination image that is clear and in which a light source image is unlikely to be visually confirmed, and a method of forming the decorative illumination image are provided.

According to the embodiment of the invention, a decorative illumination signboard in which a light source image is unlikely to be visually confirmed and a clear decorative illumination image is displayed is provided.

### BRIEF DESCRIPTION OF THE DRAWINGS

FIG. 1 is a cross-sectional view of a decorative illumination ink jet recording material having a three-layer structure according to an embodiment of the invention.

FIG. 2 is a cross-sectional view of a decorative illumination ink jet recording material having a four-layer structure including two ink accepting layers according to another embodiment of the invention.

FIG. 3 is a cross-sectional view of a decorative illumination ink jet recording material having a four-layer structure including two protective layers according to a still another embodiment of the invention.

FIG. 4 is a cross-sectional view of a decorative illumination ink jet recording material having a five-layer structure including two ink accepting layers and two protective layers according to a still another embodiment of the invention.

### DESCRIPTION OF THE PREFERRED EMBODIMENTS

Hereinafter, a decorative illumination ink jet recording material according to an embodiment of the invention will be described in detail, and further, a decorative illumination image, a method of forming the decorative illumination image, and a decorative illumination signboard according to an embodiment of the invention will also be described in detail.

In the present specification, numerical value ranges may be expressed using “to”. The numerical value ranges expressed using “to” indicate ranges including the numerical values described before and after “to” as a minimum value and a maximum value.

### <Decorative Illumination Ink Jet Recording Material>

A decorative illumination ink jet recording material according to an embodiment of the invention has at least a resin base, an ink accepting layer that contains at least white particles and is disposed on one surface of the resin base, and a protective layer that contains at least transparent particles and is disposed on the other surface of the resin base (that is, on a surface of the resin base on a side opposite to the side on which the ink accepting layer is disposed).

The decorative illumination ink jet recording material according to the embodiment of the invention is not particularly limited as long as ink jet recording can be performed thereon, and preferably has a form of a decorative illumination ink jet recording sheet, a decorative illumination ink jet recording film, or the like depending on the shape of the resin base to be used.

A display material such as a decorative illumination signboard in which in a case where external light such as sunlight or light from indoor lighting or the like enters the display material as during daytime, a reflection image that is displayed by reflection of the entering light is visually confirmed, and in a case where internal light of a light source (a so-called backlight such as a fluorescent lamp or a LED) disposed on the inside enters the display material as during the night, a transmission image that is displayed by transmission of the entering light is visually confirmed has been used for various places.

However, in such a display material suitable for use in decorative illumination, in a case where external light such as sunlight enters the display material, it is required to display a clear image by reflection or diffusion of light by a component such as a pigment in the image, and in a case where internal light of a backlight or the like mounted inside a signboard or the like enters the display material, it is required to clearly show an image by diffusion of transmitted light passing through the display material such that a light source image (lamp image) is not shown.

Based on the above, in the embodiment of the invention, an ink accepting layer containing white particles is provided on one side of the resin base, and a protective layer containing transparent particles is provided on the other side. Accordingly, the ink accepting layer containing white particles functions to clearly develop an image during reflection of external light such as sunlight or illumination light, and to adjust the transmission density of internal light from an internal light source, thereby appropriately adjusting image brightness and rarely showing an image of the internal light source. In addition, the protective layer containing transparent particles functions to diffuse internal light of a backlight or the like in addition to external light, thereby rarely showing the light source image similarly. As a result, the light source image shown in a case where transmitted light passes through the display image is unlikely to be visually confirmed, and the image can be clearly shown even in a case where either reflected light or transmitted light enters.

—Resin Base—

The decorative illumination ink jet recording material according to the embodiment of the invention is provided with a resin base.

As the resin base, a material obtained by forming a polymer compound into a film shape through a melt film forming method or a solution film forming method can be used.

Examples of the resin of the resin base include polyester (for example, polyethylene terephthalate (PET), polyethylene naphthalate (PEN), polybutylene terephthalate (PBT), polybutylene naphthalate (PBN), and the like), polyarylate, polyether sulfone, polycarbonate, polyether ketone, polysulfone, polyphenylene sulfide, polyester-based liquid crystal polymers, triacetyl cellulose, cellulose derivatives, polyolefin (for example, polypropylene), polyamide, polyimide, and polycycloolefin.

Among these, PET, PEN, triacetyl cellulose, and cellulose derivatives are more preferred, and PET and PEN are particularly preferred.

A biaxially-stretched film is preferably used as the resin base. The biaxially-stretched film can be obtained by stretching a resin sheet formed into a long film shape in two directions, that is, a longitudinal direction and a width direction perpendicular to each other. In the embodiment of the invention, a biaxially-stretched PET or PEN is particularly preferred from the viewpoint of modulus of elasticity and transparency.

Moreover, at least one of the two sides of the resin base is preferably subjected to a surface treatment such as a corona discharge treatment, a vacuum glow discharge treatment, or a flame treatment. Since the surface treatment is performed, the surface of the resin base has hydrophilic properties, and thus wettability of various aqueous coating liquids can be improved. Furthermore, functional groups such as a carboxyl group and a hydroxy group may be introduced. Accordingly, it is possible to effectively improve the adhesiveness between the resin base and the layer (for example, the ink accepting layer or the protective layer) disposed in contact with the resin base.

The thickness of the resin base is not particularly limited, and is preferably 50 μm to 350 μm from the viewpoint of handleability.

The refractive index of the resin base varies depending on the material, but it is preferably in a range of 1.40 to 1.80. In a case where the refractive index is within the above-described range, a material exhibiting excellent toughness as the resin base and having excellent transparency is obtained.

In the embodiment of the invention, at least one layer of the ink accepting layer disposed on one surface of the resin base contains at least white particles, and at least one layer of the protective layer disposed on the other surface contains at least transparent particles. The decorative illumination ink jet recording material according to the embodiment of the invention includes, for example, the following aspects.

(1) An aspect in which the ink accepting layer formed of one layer or two or more layers contains white particles, and the protective layer formed of one layer or two or more layers contains transparent particles.

(2) An aspect in which the ink accepting layer contains white particles and transparent particles, and the protective layer contains transparent particles.

(3) An aspect in which a first ink accepting layer and a second ink accepting layer are provided in order from the side close to the resin base, the first ink accepting layer contains white particles, the second ink accepting layer contains transparent particles, and the protective layer contains transparent particles.

(4) An aspect in which a first ink accepting layer and a second ink accepting layer are provided in order from the side close to the resin base, the first ink accepting layer and the second ink accepting layer contain white particles, and the protective layer contains transparent particles.

(5) An aspect in which a first protective layer and a second protective layer are provided in order from the side close to the resin base, the first protective layer contains white particles, the second protective layer contains transparent particles, and the ink accepting layer contains white particles.

(6) An aspect in which a first ink accepting layer and a second ink accepting layer are provided in order from the side close to the resin base, a first protective layer and a second protective layer are provided in order from the side close to the resin base, the first ink accepting layer contains white particles, the second ink accepting layer contains transparent particles, the first protective layer contains white particles, and the second protective layer contains transparent particles.

In the above-described aspects, from the viewpoint that in a case of being observed from the ink accepting layer side, the image becomes clearer and the light source image is more unlikely to show, in the decorative illumination ink jet recording material according to the embodiment of the invention, the ink accepting layer contains white particles, and the protective layer contains transparent particles as in Aspect (1). It is more preferable that the ink accepting layer contains white particles and transparent particles due to the same reason as in Aspect (2).

Furthermore, an aspect in which as in Aspects (3) to (6), at least one of the ink accepting layer or the protective layer is formed to have a lamination structure of two or more layers, at least one of the ink accepting layer or the protective layer closest to the resin base contains white particles, and at least one of another ink accepting layer or another protective layer contains transparent particles, or transparent particles and white particles is preferred.

Details of the white particles and the transparent particles contained in the ink accepting layer and the protective layer will be described in the section on the ink accepting layer to be described later.

Preferred amounts of the white particles and the transparent particles contained in the whole decorative illumination ink jet recording material are as follows.

The total content of the white particles in the decorative illumination ink jet recording material is preferably in a range of 1.0 g/m² to 10.0 g/m², and more preferably in a range of 1.0 g/m² to 5.0 g/m² from the viewpoint that both of reflected light and transmitted light contribute to the clearness of an image. In a case where the total content of the white particles in the decorative illumination ink jet recording material is within the above-described range, it is possible to raise the clearness of an image.

In addition, the total content of the transparent particles in the decorative illumination ink jet recording material is preferably in a range of 0.1 g/m² to 10.0 g/m², and more preferably in a range of 0.5 g/m² to 5.0 g/m² in view of increasing the diffusibility of the light passing through the recording material. In a case where the total content of the transparent particles in the decorative illumination ink jet recording material is within the above-described range, the light source image (lamp image) is unlikely to be visually confirmed, and a clear image is easily obtained.

The total content of the white particles and the transparent particles in the decorative illumination ink jet recording material is preferably in a range of 1.0 g/m² to 10.0 g/m², and more preferably in a range of 2.0 g/m² to 8.0 g/m² from the viewpoint of further increasing the clearness of an image and suppressing the light source image. In a case where the total content of the white particles and the transparent particles in the decorative illumination ink jet recording material is within the above-described range, the light source image (lamp image) is more unlikely to be visually confirmed, and the clearness of an image is also further increased.

—Ink Accepting Layer—

The ink accepting layer according to the embodiment of the invention is disposed on one surface of the resin base, that is, on one side of the resin base. The ink accepting layer is a layer on which ink droplets applied from the outside are landed, and functions to hold the landed ink.

Only one ink accepting layer may be disposed, or two or more ink accepting layers may be laminated and disposed.

The ink accepting layer can be formed using a binder resin, and may be formed as a layer further containing a crosslinking agent and obtained by crosslinking and curing. The ink accepting layer may contain white particles or transparent particles, or may contain both of white particles and transparent particles. If necessary, additives such as a surfactant and a lubricant can be used for the formation.

(Binder Resin)

Examples of the binder resin include polyester, polyurethane, an acrylic resin, a styrene-butadiene copolymer, and polyolefin. The binder resin is preferably water-soluble or water-dispersible in view of less environmental load.

The binder resins may be used alone or in combination of two or more types thereof.

Polyester is a general term for polymers whose main chain has an ester bond and can be generally obtained by a reaction between a dicarboxylic acid and a polyol. Examples of the dicarboxylic acid include fumaric acid, itaconic acid, adipic acid, sebacic acid, terephthalic acid, isophthalic acid, sulfoisophthalic acid, and naphthalene dicarboxylic acid. Examples of the polyol include ethylene glycol, propylene glycol, glycerin, hexanetriol, butanediol, hexanediol, and 1,4-cyclohexanedimethanol.

Polyester and the raw material thereof are described in “Handbook of Polyester Resin” (written by Eiichiro Takiyama, NIKKAN KOGYO SHIMBUN, LTD., published in 1988), and the description can be applied to the invention.

Examples of the polyester include polyhydroxy butyrate (PHB)-based, polycaprolactone (PCL)-based, polycaprolactone butylene succinate-based, polybutylene succinate (PBS)-based, polybutylene succinate adipate (PBSA)-based, polybutylene succinate carbonate-based, polyethylene terephthalate succinate-based, polybutylene adipate terephthalate-based, polytetramethylene adipate terephthalate-based, polybutylene adipate terephthalate-based, polyethylene succinate (PES)-based, polyglycolic acid (PGA)-based, and polylactic acid (PLA)-based polyesters, a carbonate copolymer of aliphatic polyester, and a copolymer of aliphatic polyester and polyamide.

As the polyester, a commercially available product may be used, and examples thereof include FINETEX (registered trademark) ES650, ES2200 (manufactured by DIC Corporation), VYLONAL (registered trademark) MD1245, MD1400, MD 1480 (manufactured by TOYOBO CO., LTD.), PESUREJIN A-110, A-124GP, A-520, A-640 (manufactured by TAKAMATSU OIL & FAT CO., LTD.), PLASCOAT Z561, Z730, Z687, and Z592 (manufactured by GOO CHEMICAL CO., LTD.).

Polyurethane is a general term for polymers whose main chain has a urethane bond and can be generally obtained by a reaction between a diisocyanate and a polyol.

Examples of the diisocyanate include toluene diisocyanate (TDI), diphenylmethane diisocyanate (MDI), naphthalene diisocyanate (NDI), tolidine diisocyanate (TODI), hexamethylene diisocyanate (HDI), and isophorone diisocyanate (IPDI). Examples of the polyol include ethylene glycol, propylene glycol, glycerin, and hexanetriol.

Furthermore, as the isocyanate, a polymer whose molecular weight is increased by performing a chain extension treatment on the polyurethane polymer obtained by the reaction between a diisocyanate and a polyol can also be used.

Regarding the above-described diisocyanates, polyols, and chain extension treatment, refer to the description in “Handbook of Polyurethane” (edited by Keiji Iwata, NIKKAN KOGYO SHIMBUN, LTD., published in 1987).

As the polyurethane, a commercially available product may be used, and examples thereof include SUPERFLEX (registered trademark) 470, 210, 150HS, ELASTRON (registered trademark) H-3 (manufactured by DKS Co., Ltd.), HYDRAN (registered trademark) AP-20, AP-40F, WLS-210 (manufactured by DIC Corporation), TAKELAC (registered trademark) W-5100, W-6061, and OLESTER (registered trademark) UD-350 (manufactured by Mitsui Chemicals, Inc.).

An acrylic resin is a polymer obtained by polymerizing a polymerizable monomer having a carbon-carbon double bond, that is represented by an acrylic monomer or a methacrylic monomer. The acrylic resin may be a homopolymer or a copolymer of an acrylic monomer or a methacrylic monomer, and also includes copolymers of the polymers and other polymers (for example, polyester, polyurethane, and the like). The copolymer is, for example, a block copolymer or a graft copolymer. In addition, the acrylic resin also includes polymers (mixtures of polymers in some cases) obtained by polymerizing polymerizable monomers having a carbon-carbon double bond in a polyester solution or a polyester dispersion liquid, and polymers (mixtures of polymers in some cases) obtained by polymerizing polymerizable monomers having a carbon-carbon double bond in a polyurethane solution or a polyurethane dispersion liquid. Similarly, the acrylic resin also includes polymers (mixtures of polymers in some cases) obtained by polymerizing polymerizable monomers having a carbon-carbon double bond in another polymer solution or dispersion liquid.

In order to further improve adhesion to the adjacent layer, a hydroxy group or an amino group may be included.

The polymerizable monomer having a carbon-carbon double bond is not particularly limited, and examples of the monomer as a representative compound include various carboxyl group-containing monomers such as acrylic acid, methacrylic acid, crotonic acid, itaconic acid, fumaric acid, maleic acid, and citraconic acid and salts thereof; various hydroxyl group-containing monomers such as 2-hydroxyethyl (meth)acrylate, 2-hydroxypropyl (meth)acrylate, 4-hydroxybutyl (meth)acrylate, monobutyl hydroxy fumarate, and monobutyl hydroxy itaconate; various (meth)acrylic acid esters such as methyl (meth)acrylate, ethyl (meth)acrylate, propyl (meth)acrylate, butyl (meth)acrylate, and lauryl (meth)acrylate; various nitrogen-containing compounds such as (meth)acrylamide, diacetone acrylamide, N-methylol acrylamide, and (meth)acrylonitrile; various styrene derivatives such as styrene, α-methylstyrene, divinyl benzene, and vinyl toluene; various vinyl esters such as vinyl propionate; various silicon-containing polymerizable monomers such as γ-methacryloxy propyl trimethoxysilane and vinyl trimethoxysilane; phosphorus-containing vinyl-based monomers; various halogenated vinyls such as vinyl chloride and vinylidene chloride; and various conjugated dienes such as butadiene.

As the acrylic resin, a commercially available product may be used, and examples thereof include JURYMER (registered trademark) ET-410 (manufactured by TOAGOSEI CO., LTD.) and AS-563A (manufactured by DAICEL FINECHEM LTD.).

Polyolefin is a polymer obtained by polymerizing an alkene such as ethylene, propylene, and butylene. The polyolefin may be a copolymer of an alkene and another monomer, and examples thereof include the following copolymers.

A copolymer of ethylene or propylene and an acrylic monomer or a methacrylic monomer

A copolymer of ethylene or propylene and a carboxylic acid (including anhydride)

A copolymer of ethylene or propylene, an acrylic monomer or a methacrylic monomer, and a carboxylic acid (including anhydride)

Specific preferred examples of the acrylic monomer or the methacrylic monomer for forming the copolymer include methyl methacrylate, ethyl acrylate, butyl acrylate, and 2-hydroxyethyl acrylate.

Specific preferred examples of the carboxylic acid for forming the copolymer include acrylic acid, methacrylic acid, itaconic acid, maleic acid, and maleic acid anhydride.

These may be used alone or as a mixture of plural types thereof.

The polyolefin may be used in the form of an aqueous polymer dispersion (so-called latex). Specific examples of commercially available products thereof as a latex include BONDINE HX-8210, HX-8290, TL-8030, LX-4110 (all manufactured by Sumitomo Chemical Co., Ltd.), ARROWBASE (registered trademark) SA-1200, SB-1010, SE-1013N, SE-1200 (all manufactured by UNITIKA LTD.), and Nipol series (manufactured by ZEON Corporation).

The content of the binder resin in the ink accepting layer is preferably 25 mass % to 90 mass %, and more preferably 30 mass % to 80 mass % with respect to the total solid content of the layer. In a case where two or more types of binder resins are included, the total amount of the binder resin may be within the above-described range.

(Crosslinking Agent)

The ink accepting layer according to the embodiment of the invention may contain at least one type of crosslinking agent.

Preferred examples of the crosslinking agent include oxazoline-based compounds and carbodiimide-based compounds.

[Oxazoline-Based Compound]

An oxazoline-based compound is a compound having an oxazoline group represented by the following Formula (1).

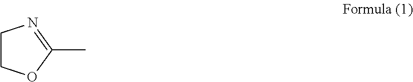

Examples of the oxazoline-based compound include a polymer having an oxazoline group, for example, a polymer obtained by copolymerizing a polymerizable unsaturated monomer having an oxazoline group with another polymerizable unsaturated monomer as needed through a known method (for example, solution polymerization or emulsion polymerization).

Examples of the polymerizable unsaturated monomer having an oxazoline group include monomers containing 2-vinyl-2-oxazoline, 2-vinyl-4-methyl-2-oxazoline, 2-vinyl-5-methyl-2-oxazoline, 2-isopropenyl-2-oxazoline, 2-isopropenyl-4-methyl-2-oxazoline, or 2-isopropenyl-5-methyl-2-oxazoline in units of monomer.

These monomers may be used in combination of two or more types thereof.

As the oxazoline-based compound, a commercially available product may be used, and examples thereof include EPOCROS (registered trademark) K-2020E, EPOCROS K-2010E, EPOCROS K-2020E, EPOCROS K-2030E, EPOCROS WS-300, EPOCROS WS-500, and EPOCROS WS-700 (all manufactured by NIPPON SHOKUBAI CO., LTD.).

[Carbodiimide-Based Compound]

A carbodiimide-based compound is a compound having a functional group represented by —N═C═N—. In general, polycarbodiimide is synthesized by a condensation reaction of organic diisocyanate. An organic group of the organic diisocyanate to be used for the synthesis is not particularly limited, and any one of an aromatic group and an aliphatic group, or a mixture thereof can be used. From the viewpoint of reactivity, an aliphatic group is particularly preferred. As raw materials for synthesis, organic isocyanate, organic diisocyanate, organic triisocyanate, or the like is used.

Examples of the organic isocyanate include isophorone isocyanate, phenyl isocyanate, cyclohexyl isocyanate, butyl isocyanate, and naphthyl isocyanate.

Examples of the organic diisocyanate include aromatic diisocyanate, aliphatic diisocyanate, and mixtures thereof. Specific examples thereof include 4,4′-diphenylmethane diisocyanate, 4,4-diphenyldimethylmethane diisocyanate, 1,4-phenylene diisocyanate, 2,4-tolylene diisocyanate, 2,6-tolylene diisocyanate, hexamethylene diisocyanate, cyclohexane diisocyanate, xylylene diisocyanate, 2,2,4-trimethylhexamethylene diisocyanate, 4,4′-dicyclohexylmethane diisocyanate, and 1,3-phenylene diisocyanate.

As the carbodiimide-based compound, a commercially available product may be used, and examples thereof include CARBODILITE (registered trademark) V-02-L2 (manufactured by Nisshinbo Holdings Inc.).

The content of the crosslinking agent is preferably in a range of 3 mass % to 40 mass %, and more preferably in a range of 3 mass % to 35 mass % with respect to the binder resin. In a case where the content of the crosslinking agent is within the above-described range, the adhesion between the resin base and the ink accepting layer is further improved. In a case where the content of the crosslinking agent is 3 mass % or greater with respect to the binder resin, penetration of an applied ink into the ink accepting layer is improved, and thus ink adhesion properties immediately after the image formation are easily increased. In addition, in a case where the content of the crosslinking agent is 40 mass % or less with respect to the binder resin, the crosslinking reaction in the ink accepting layer is suppressed and the hardness of the layer is thus prevented from being excessively increased, whereby ink adhesion properties after the thermo-treatment are easily increased.

(White Particles)

The ink accepting layer according to the embodiment of the invention may contain white particles. The white particles are particles in which a degree of whiteness measured by performing the measurement on a dispersion liquid obtained by adding and dispersing 5 g of the particles in 100 ml of a solvent with a compact whiteness meter (NW-11 manufactured by NIPPON DENSHOKU INDUSTRIES CO., LTD) is 60 or greater.

The white particles include inorganic particles such as a white pigment and white organic particles.

Examples of the white pigment include barium sulfate, antimony oxide, selenium oxide, titanium oxide, tungsten oxide, silicon oxide, aluminum oxide, magnesium oxide, zinc oxide, zinc antimonite, calcium carbonate, kaolin, and talc.

Examples of the white organic particles include particles in which organic particles that are transparent particles to be described later are colored white.

Titanium dioxide is particularly preferred as the white particles in view of the fact that a clearer decorative illumination image can be obtained.

As the white particles, a commercially available product may be used, and examples thereof include TIPAQUE (registered trademark) CR-93, CR-95, R780-2 (all manufactured by ISHIHARA SANGYO KAISHA, LTD.), TITANIX (registered trademark) JR-603, TITANIX JR-805 (all manufactured by TAYCA), and TI-PURE (registered trademark) R706 (E. I. du Pont de Nemours and Company).

The average primary particle diameter of the white particles is preferably in a range of 0.1 μm to 0.5 μm and more preferably in a range of 0.1 μm to 0.3 μm in view of further increasing the clearness of an image.

The average primary particle diameter is obtained from a photograph obtained by observing particles of a cross-section of the layer using a transmission electron microscope. Specifically, projected areas of the particles are obtained, and an equivalent circle diameter is obtained from the projected areas and defined as an average particle diameter (average primary particle diameter). The average primary particle diameter is a value calculated by measuring projected areas of 300 or more particles and obtaining an equivalent circle diameter.

The white particles may be used alone or in combination of two or more types thereof.

In a case where the ink accepting layer contains the white particles, the content of the white particles in a single ink accepting layer is preferably 15 mass % to 90 mass %, and more preferably 30 mass % to 70 mass % with respect to the total solid content of the layer. In a case where the content of the white particles in the ink accepting layer is within the above-described range, it is possible to raise the clearness of an image while balancing the adhesiveness of the image to the ink accepting layer and the adhesiveness between the ink accepting layer and the resin base.

(Transparent Particles)

The ink accepting layer according to the embodiment of the invention may contain transparent particles. The transparent particles are particles in which a degree of whiteness measured by performing the measurement on a dispersion liquid obtained by adding and dispersing 5 g of the particles in 100 ml of a solvent with a compact whiteness meter (NW-11 manufactured by NIPPON DENSHOKU INDUSTRIES CO., LTD) is less than 60.

Examples of the transparent particles include inorganic particles such as tin oxide, antimony-doped tin oxide (ATO (tin oxide doped with antimony)), phosphorus-doped tin oxide, tin-doped indium oxide, silica, and colloidal silica, and polymer particles such as polystyrene, a polystyrene-divinylbenzene copolymer, polymethylmethacrylate (hereinafter, PMMA), crosslinked polymethylmethacrylate (hereinafter, crosslinked PMMA), a styrene/acrylic copolymer, a melamine resin, and a benzoguanamine resin, and hollow particles can also be preferably used.

Among these, preferred transparent particles are particles of a polymer selected from the group consisting of a melamine resin, polystyrene, a styrene/acrylic copolymer, PMMA, crosslinked PMMA, and a silicone resin, and the most preferred transparent particles are crosslinked PMMA particles.

As the transparent particles, a commercially available product may be used, and examples thereof include, as inorganic particles, SNOWTEX (registered trademark) MP-2040 (manufactured by NISSAN CHEMICAL INDUSTRIES. LTD.), FS-10D (manufactured by ISHIHARA SANGYO KAISHA, LTD.), and as polymer particles, MR-2G MX-150, MX-180, MX-80H3WT (all are crosslinked PMMA particles manufactured by Soken Chemical & Engineering Co., Ltd.), and Nipol series such as Nipol UFN1008 (manufactured by ZEON Corporation).

The average primary particle diameter of the transparent particles is preferably in a range of 0.1 μm to 1.5 μm, and more preferably in a range of 0.3 μm to 1.0 μm in view of increasing light diffusibility in the layer.

The average primary particle diameter of the transparent particles can be measured in the same manner as in the above-described measurement of the average primary particle diameter of the white particles.

The transparent particles may be used alone or in combination of two or more types thereof.

In a case where the ink accepting layer contains the transparent particles, the content of the transparent particles in a single ink accepting layer is preferably 1 mass % to 30 mass %, and more preferably 3 mass % to 20 mass % with respect to the total solid content of the layer. The content of the transparent particles in the ink accepting layer is preferably within the above-described range in order to clearly show an image so as not to show a light source image while balancing the image adhesiveness of the ink accepting layer and the adhesiveness between the ink accepting layer and the resin base.

In a case where the ink accepting layer is formed to have a lamination structure of two or more layers including a first ink accepting layer and a second ink accepting layer disposed in order from the resin base side, the white particles and the transparent particles may be contained in any aspect in the first ink accepting layer and the second ink accepting layer. Among these, it is preferable that the first ink accepting layer contains the white particles and the second ink accepting layer contains the transparent particles from the viewpoint that the clearness of an image is raised and a light source image is more unlikely to show.

(Other Additives)

The ink accepting layer according to the embodiment of the invention may contain, if necessary, additives such as a surfactant, a dispersing agent, a catalyst, a lubricant, an anti-foaming agent, a foam suppressor, a dye, a fluorescent whitening agent, a preservative, a water resistant additive, particles, and distilled water, other than the binder resin, the crosslinking agent, the white particles, and the transparent particles.

Examples of the surfactant include known anionic surfactants, nonionic surfactants, cationic surfactants, fluorine-based surfactants, and silicone-based surfactants. The surfactant is described in, for example, “Handbook of Surfactants” (edited by Ichiro Nishi, Ichiro Imai, and Masatake Kasai, Sangyo-Tosho Publishing Co., Ltd., published in 1960). As the surfactant, an anionic surfactant and/or a nonionic surfactant is particularly preferred.

The surfactants may be used alone or in combination of two or more types thereof.

As the surfactant, a commercially available product may be used.

Examples of commercially available anionic surfactant include RAPISOL (registered trademark) A-90, A-80, BW-30, B-90, C-70 (all manufactured by NOF CORPORATION); NIKKOL (registered trademark) OTP-100 (all manufactured by NIKKO CHEMICALS CO., LTD.), KOHAKURU (registered trademark) ON, L-40, PHOSPHANOL (registered trademark) 702 (all manufactured by Toho Chemical Industry Co., Ltd.), BEAULIGHT (registered trademark) A-5000, and SSS (all manufactured by Sanyo Chemical Industries, Ltd.).

Examples of commercially available nonionic surfactant include NAROACTY (registered trademark) CL-95, HN-100 (trade name: manufactured by Sanyo Chemical Industries, Ltd.), LITHO REX BW400 (trade name: manufactured by KOKYU ALCOHOL KOGYO CO., LTD.), EMALEX (registered trademark) ET-2020 (all manufactured by Nihon Emulsion Co., Ltd.), UNILUBE (registered trademark) 50MB-26, and NONION (registered trademark) IS-4 (all manufactured by NOF CORPORATION).

Examples of commercially available fluorine-based surfactant include MEGAFAC (registered trademark) F171, MEGAFAC F172, MEGAFAC F173, MEGAFAC F176, MEGAFAC F177, MEGAFAC F141, MEGAFAC F142, MEGAFAC F143, MEGAFAC F144, MEGAFAC R30, MEGAFAC F437, MEGAFAC F475, MEGAFAC F479, MEGAFAC F482, MEGAFAC F554, MEGAFAC F780, MEGAFAC F781 (all manufactured by DIC Corporation), FLUORAD FC430, FLUORAD FC431, FLUORAD FC171 (all manufactured by Sumitomo 3M Limited), SURFLON (registered trademark) S-382, SURFLON SC-101, SURFLON SC-103, SURFLON SC-104, SURFLON SC-105, SURFLON SC1068, SURFLON SC-381, SURFLON SC-383, SURFLON 5393, SURFLON KH-40 (all manufactured by ASAHI GLASS CO., LTD.), PF636, PF656, PF6320, PF6520, and PF7002 (manufactured by OMNOVA Solutions Inc.).

Examples of commercially available cationic surfactant include a phthalocyanine derivative (trade name: EFKA-745 manufactured by MORISHITA & CO., LTD.), organosiloxane polymer KP341 (manufactured by Shin-Etsu Chemical Co., Ltd.), (meth)acrylic acid-based (co)polymer polyflow No. 75, No. 90, No. 95 (manufactured by KYOEISHA CHEMICAL Co., LTD.), and WO01 (manufactured by Yusho Co., Ltd.).

Examples of commercially available silicone-based surfactant include TORAY SILICONE DC3PA, TORAY SILICONE SH7PA, TORAY SILICONE DC11PA, TORAY SILICONE SH21PA, TORAY SILICONE SH28PA, TORAY SILICONE SH29PA, TORAY SILICONE SH30PA, TORAY SILICONE SH8400 (all manufactured by Dow Corning Corporation), TSF-4440, TSF-4300, TSF-4445, TSF-4460, TSF-4452 (all manufactured by Momentive Performance Materials Inc.), KP341, KF6001, KF6002 (all manufactured by Shin-Etsu Chemical Co., Ltd.), BYK307, BYK323, and BYK330 (all manufactured by BYK Additives & Instruments).

As the lubricant, an aliphatic wax or the like is preferably used.

Specific examples of the aliphatic wax include vegetable waxes such as a carnauba wax, a candelilla wax, a rice wax, a Japan wax, jojoba oil, a palm wax, a rosin-modified wax, an ouricury wax, a sugar cane wax, an esparto wax, and a bark wax; animal waxes such as a bees wax, lanolin, a whale wax, an insect wax, and a shellac wax; mineral waxes such as a montan wax, ozocerite, and a ceresin wax; petroleum-based waxes such as a paraffin wax, a microcrystalline wax, and petrolactam; and synthetic hydrocarbon-based waxes such as a Fischer-Tropsch wax, a polyethylene wax, a polyethylene oxide wax, a polypropylene wax, and a polypropylene oxide wax. Among these, a carnauba wax, a paraffin wax, and a polyethylene wax are particularly preferred.

These are preferably used as an aqueous dispersion in view of less environmental load and good handleability. Examples of commercially available products thereof include CELLOSOL (registered trademark) 524 (manufactured by CHUKYO YUSHI CO., LTD.). The lubricants may be used alone or in combination of two or more types thereof.

Examples of the preservative include sodium dehydroacetate, sodium benzoate, sodium pyridinethione-1-oxide, p-hydroxybenzoic acid ethyl ester, 1,2-benzothiazoline-3-on, sodium sorbate, and sodium pentachlorophenol.

The thickness of the ink accepting layer is, for example, preferably 0.1 μm to 10.0 μm, and more preferably 0.1 μm to 6.0 μm.

—Protective Layer—

The protective layer according to the embodiment of the invention is disposed on the other side of the resin base, that is, on the resin base on a side opposite to the side having the ink accepting layer. Only one protective layer may be disposed, or two or more protective layers may be laminated and disposed depending on the object or situation.

The protective layer contains at least one of the above-described white particles or transparent particles, and preferably further contains an alkoxysilane compound and a surfactant. If necessary, the protective layer may further contain other components such as an antistatic agent, a wax, and a curable component.

(Alkoxysilane Condensation Compound)

The protective layer according to the embodiment of the invention may contain at least one type of condensation compound obtained by hydrolyzing and condensing an alkoxysilane compound.

In the embodiment of the invention, the protective layer is preferably formed using a tetrafunctional alkoxysilane and at least one of a trifunctional alkoxysilane or a bifunctional alkoxysilane as an alkoxysilane compound.

In the embodiment of the invention, the trifunctional or bifunctional alkoxysilane may contain only one of a trifunctional alkoxysilane and a bifunctional alkoxysilane, or may contain both of a trifunctional alkoxysilane and a bifunctional alkoxysilane. Among these, a trifunctional alkoxysilane is preferably contained.

The tetrafunctional alkoxysilane and the trifunctional or bifunctional alkoxysilane are preferably hydrolyzed in an acidic aqueous solution to generate a silanol, and contained as a compound (for example, an oligomer) obtained by condensing the silanol groups.

The trifunctional alkoxysilane and the bifunctional alkoxysilane may be used in mixture.

—Trifunctional or Bifunctional Alkoxysilane—

As the trifunctional or bifunctional alkoxysilane, a trifunctional or bifunctional alkoxysilane represented by the following Formula (1) is preferred.

Rₙ₊₁Si(OR¹)₃₋ₙ Formula (1)

In the formula, R represents an organic group having 1 to 15 carbon atoms containing no amino group (The organic group may be unsubstituted or may have a substituent. Examples of the organic group include an alkyl group having 1 to 15 carbon atoms (for example, methyl, ethyl, and propyl), an alkenyl group having 2 to 15 carbon atoms (for example, vinyl), an alkoxy group having 1 to 15 carbon atoms (for example, methacryloxy and glycidoxy), and an aryl group having 6 to 15 carbon atoms (for example, phenyl)), and R¹ represents an alkyl group having 4 or more carbon atoms (preferably a methyl group, an ethyl group, and the like). n is 0 or 1.

The alkoxysilane represented by Formula (1) does not contain an amino group as a functional group. That is, in a case where R in Formula (1) has an amino group, dehydration condensation of silanol groups is easily promoted during the hydrolysis in a case where the alkoxysilane is mixed with a tetrafunctional alkoxysilane to be described later. Therefore, in a case where R does not contain an amino group, a coating liquid for a protective layer can be more stably maintained.

R may be an organic group having a molecular chain with 1 to 15 carbon atoms. In a case where the number of carbon atoms is 15 or less, flexibility of the protective layer is not excessively increased, and the hardness can be maintained. As for R, the number of carbon atoms is preferably in a range of 3 to 15, and more preferably in a range of 5 to 13. In a case where the number of carbon atoms of R is within the above-described range, a layer having further improved brittleness is obtained.

The organic group represented by R preferably has heteroatoms such as an oxygen, nitrogen, and sulfur. In a case where the organic group has heteroatoms, the adhesiveness between the resin base and the protective layer is further improved. Particularly, the organic group preferably has an epoxy group, an amide group, a urethane group, a urea group, an ester group, a hydroxy group, a carboxyl group, and the like. Among these, a trifunctional or bifunctional alkoxysilane having an epoxy group is preferred in view of the fact that it has an effect of increasing stability of a silanol in acidic water. In addition, the trifunctional or bifunctional alkoxysilane having an epoxy group can apply hardness while imparting suitable flexibility.

As R¹ in Formula (1), a methyl group or an ethyl group is preferred. In a case where R¹ is an alkyl group having 4 or more carbon atoms, hydrophilic properties of the trifunctional or bifunctional alkoxysilane can be increased, and thus hydrolysis in the aqueous solution can be promoted.

In Formula (1), in a case where n is 0, the compound represented by Formula (1) represents a trifunctional alkoxysilane, and in a case where n is 1, and the compound represented by Formula (1) represents a bifunctional alkoxysilane.

Examples of preferred compounds from among trifunctional or bifunctional alkoxysilanes represented by Formula (1) include vinyltrimethoxysilane, 3-methacryloxypropyltrimethoxysilane, 3-acryloxypropyltrimethoxysilane, 3-chloropropyltrimethoxysilane, 3-ureidopropyltrimethoxysilane, propyltrimethoxysilane, phenyltrimethoxysilane, 3-glycidoxypropyltriethoxysilane, 2-(3,4-epoxycyclohexyl)ethyltriethoxysilane, vinyltriethoxysilane, 3-methacryloxypropyltriethoxysilane, 3-acryloxypropyltriethoxysilane, 3-chloropropyltriethoxysilane, 3-ureidopropyltriethoxysilane, propyltriethoxysilane, phenyltriethoxysilane, 3-glycidoxypropylmethyldimethoxysilane, 2-(3,4-epoxycyclohexyl)ethylmethyldimethoxysilane, vinylmethyldimethoxysilane, 3-methacryloxypropylmethyldimethoxysilane, 3-acryloxypropylmethyldimethoxysilane, chloropropylmethyldimethoxysilane, propylmethyldimethoxysilane, phenylmethyldimethoxysilane, 3-glycidoxypropylmethyldiethoxysilane, 2-(3,4-epoxycyclohexyl)ethylmethyldiethoxysilane, vinylmethyldiethoxysilane, 3-methacryloxypropylmethyldiethoxysilane, 3-acryloxypropylmethyldiethoxysilane, chloropropylmethyldiethoxysilane, propylmethyldiethoxysilane, phenylmethyldiethoxysilane, 3-trimethoxysilylpropyl-2-[2-(methoxyethoxy)ethoxy]ethylurethane, 3-triethoxysilylpropyl-2-[2-(methoxyethoxy)ethoxy]ethylurethane, 3-trimethoxysilylpropyl-2-[2-(methoxypropoxy)propoxy]propylurethane, 3-triethoxysilylpropyl-2-[2-(methoxypropoxy)propoxy]propylurethane, 3-glycidoxypropylmethyldimethoxysilane, 3-glycidoxypropylmethyldiethoxysilane, 3-methacryloxypropylmethyldimethoxysilane, 3-methacryloxypropylmethyldiethoxysilane, and 3-mercaptopropylmethyldimethoxysilane.

Among these, a trialkoxysilane in which n is 0 is more preferred, and examples thereof include 3-glycidoxypropyltrimethoxysilane, 3-glycidoxypropyltriethoxysilane, 3-chloropropyltrimethoxysilane, 2-(3,4-epoxycyclohexyl)ethyltrimethoxysilane, 3-ureidopropyltriethoxysilane, 3-trimethoxysilylpropyl-2-[2-(methoxyethoxy)ethoxy]ethylurethane, and 3-trimethoxysilylpropyl-2-[2-(methoxypropoxy)propoxy]propylurethane.

A commercially available product may be used, and examples thereof include KBE-403 (manufactured by Shin-Etsu Chemical Co., Ltd.).

—Tetrafunctional Alkoxysilane—

In a case where a tetrafunctional alkoxysilane is used together with the above-described trifunctional or bifunctional alkoxysilane, the crosslinking density is increased due to dehydration condensation of silanol groups generated by the hydrolysis of the alkoxysilane. In a case where the crosslinking density is increased, the hardness of the protective layer is increased.

The tetrafunctional alkoxysilane is not particularly limited. The tetrafunctional alkoxysilane preferably has 1 to 4 carbon atoms, and is particularly preferably a tetramethoxysilane or a tetraethoxysilane. In a case where the number of carbon atoms is 4 or less, the hydrolysis rate of the tetrafunctional alkoxysilane at the time of being mixed with acidic water can be well maintained, and a uniform aqueous solution can be prepared in a shorter period of time. Accordingly, the manufacturing efficiency is improved.

As the tetrafunctional alkoxysilane, a commercially available product may be used, and examples thereof include KBE-04 (manufactured by Shin-Etsu Chemical Co., Ltd.).

In a case where a tetrafunctional alkoxysilane and at least one of a trifunctional alkoxysilane or a bifunctional alkoxysilane are contained as the alkoxysilane compound, the tetrafunctional alkoxysilane and the trifunctional alkoxysilane and bifunctional alkoxysilane are preferably contained at a ratio of 25:75 to 85:15 (molar ratio; =tetrafunctional:trifunctional+bifunctional). This molar ratio is more preferably in a range of 30:70 to 80:20, even more preferably in a range of 30:70 to 65:35, and yet even more preferably in a range of 45:55 to 65:35.

In a case where the molar ratio between the tetrafunctional alkoxysilane and the trifunctional alkoxysilane and bifunctional alkoxysilane is within the above-described range, the degree that a light source image is shown can be reduced without enhancing haze.

(White Particles, Transparent Particles)

The protective layer according to the embodiment of the invention contains at least transparent particles, and preferably contains transparent particles and white particles. Details of the white particles and the transparent particles are as described above.

The white particles and the transparent particles may be used alone or in combination of two or more types thereof, respectively.

In a case where the protective layer contains the white particles, the content of the white particles in a single protective layer is preferably 15 mass % to 90 mass %, and more preferably 30 mass % to 70 mass % with respect to the total solid content of the layer. In a case where the content of the white particles in the protective layer is within the above-described range, it is possible to raise the clearness of an image without damage on the adhesiveness between the protective layer and the resin base or the adjacent layer.

In a case where the protective layer contains the transparent particles, the content of the transparent particles in a single protective layer is preferably 1 mass % to 30 mass %, and more preferably 3 mass % to 20 mass % with respect to the total solid content of the layer. The content of the transparent particles in the protective layer is preferably within the above-described range in order to clearly show an image so as not to show a light source image without damage on the adhesiveness between the protective layer and the resin base or the adjacent layer.

In a case where the protective layer according to the embodiment of the invention is formed to have a lamination structure of two or more layers including a first protective layer and a second protective layer disposed in order from the resin base side, the white particles and the transparent particles may be contained in any aspect in the first protective layer and the second protective layer. Among these, it is preferable that the first protective layer contains the white particles and the second protective layer contains the transparent particles from the viewpoint that the clearness of an image is raised and a light source image is more unlikely to show.

(Surfactant)

The protective layer according to the embodiment of the invention may contain at least one type of surfactant.

Examples of the surfactant include known anionic surfactants, nonionic surfactants, cationic surfactants, fluorine-based surfactants, and silicone-based surfactants. Regarding details of these surfactant, the description in “Handbook of Surfactants” (edited by Ichiro Nishi, Ichiro Imai, and Masatake Kasai, Sangyo-Tosho Publishing Co., Ltd., published in 1960) can be referred to.

Among these, anionic surfactants and cationic surfactants are preferred.

Examples of the anionic surfactants include higher fatty acid salts such as potassium stearate and potassium behenate, alkyl ether carboxylates such as sodium polyoxyethylene (hereinafter, abbreviated as POE) lauryl ether carboxylate, N-acyl-L-glutamates such as N-stearoyl-L-glutamic acid monosodium salt, higher alkyl sulfate ester salts such as sodium lauryl sulfate and potassium lauryl sulfate, alkyl ether sulfate ester salts such as POE lauryl sulfate triethanolamine and sodium POE lauryl sulfate, N-acyl sarcosinates such as sodium lauryl sarcosine, higher fatty acid amide sulfonates such as sodium N-myristoyl-N-methyl taurine, alkyl phosphates such as sodium stearyl phosphate; alkyl ether phosphates such as sodium POE oleyl ether phosphate and sodium POE stearyl ether phosphate, sulfosuccinates such as sodium di-2-ethylhexyl sulfosuccinate, sodium monolauroyl monoethanolamide polyoxyethylene sulfosuccinate, and sodium lauryl polypropylene glycol sulfosuccinate, alkyl benzene sulfonates such as sodium linear dodecyl benzene sulfonate, linear dodecyl benzene, sulfonic acid triethanolamine, linear dodecyl benzene sulfonate, and dodecyl diphenyl ether disulfonate, and higher fatty acid ester sulfate ester salts such as cured coconut oil fatty acid sodium glycerin sulfate.

A commercially available anionic surfactant may be used, and examples thereof include RAPISOL (registered trademark) A-90, A-80, BW-30, B-90, C-70 (trade name; manufactured by NOF CORPORATION); NIKKOL (registered trademark) OTP-100 (trade name; manufactured by NIKKO CHEMICALS CO., LTD.), KOHAKURU (registered trademark) ON, KORAKURU (registered trademark) L-40, PHOSPHANOL (registered trademark) 702 (trade name; manufactured by Toho Chemical Industry Co., Ltd.), BEAULIGHT (registered trademark) A-5000, SSS, and SANDEDDO (registered trademark) BL (trade name; manufactured by Sanyo Chemical Industries, Ltd.).

Examples of the cationic surfactants include alkyl trimethyl ammonium salts such as stearyl trimethyl ammonium chloride and lauryl trimethyl ammonium chloride, dialkyl dimethyl ammonium salts such as distearyl dimethyl ammonium chloride, alkyl pyridinium salts such as poly(N,N-dimethyl-3,5-methylene piperidinium) chloride and cetyl pyridinium chloride, alkyl quaternary ammonium salts, alkyl dimethyl benzyl ammonium salts, alkyl isoquinolinium salts, dialkyl morpholinium salts, POE alkylamines, alkylamine salts, polyamine fatty acid derivatives, amyl alcohol fatty acid derivatives, benzalkonium chlorides, and benzethonium chloride. It is possible to suppress aggregation of particles during drying of a coating film and to form uniform unevenness on the surface using the above-described surfactant.

A commercially available anionic surfactant may be used, and examples thereof include a phthalocyanine derivative (trade name: EFKA-745 manufactured by MORISHITA & CO., LTD.), organosiloxane polymer KP341 (manufactured by Shin-Etsu Chemical Co., Ltd.), (meth)acrylic acid-based (co)polymer polyflow No. 75, No. 90, No. 95 (manufactured by KYOEISHA CHEMICAL Co., LTD.), and WO01 (manufactured by Yusho Co., Ltd.).

Examples of commercially available products of the nonionic surfactants include NAROACTY (registered trademark) CL-95, HN-100 (trade name; manufactured by Sanyo Chemical Industries, Ltd.), LITHO REX BW400 (manufactured by KOKYU ALCOHOL KOGYO CO., LTD.), EMALEX (registered trademark) ET-2020 (manufactured by Nihon Emulsion Co., Ltd.), UNILUBE (registered trademark) 50MB-26, and NONION (registered trademark) IS-4 (manufactured by NOF CORPORATION).

In a case where the protective layer contains a surfactant, the content of the surfactant in the protective layer is preferably in a range of 0.01 mass % to 1 mass % with respect to the mass of the solvent in the coating liquid.

(Other Components)

If necessary the protective layer according to the embodiment of the invention may further contain other components such as a wax, a curing agent, a curable component, and an antistatic agent in addition to the above-described components.

In a case where a wax is contained, surface characteristics, particularly, a friction coefficient of the decorative illumination ink jet recording material can be controlled. Examples of the wax include a paraffin wax, a micro wax, a polyethylene wax, a polyester-based wax, a carnauba wax, a fatty acid, a fatty acid amide, and metallic soap.

In a case where a curing agent is contained, dehydration condensation of the silanol in the protective layer is promoted, and thus the formation of a siloxane bond can be promoted. The curing agent is preferably water-soluble. Examples of the water-soluble curing agent include water-soluble inorganic acids, organic acids, organic acid salts, inorganic acid salts, metallic alkoxides, and metal complexes.

Preferred examples of the inorganic acids include boric acid, phosphoric acid, hydrochloric acid, nitric acid, and sulfuric acid. Preferred examples of the organic acids include acetic acid, formic acid, oxalic acid, citric acid, malic acid, and ascorbic acid. Preferred examples of the organic acid salts include aluminum acetate, aluminum oxalate, zinc acetate, zinc oxalate, magnesium acetate, magnesium oxalate, zirconium acetate, and zirconium oxalate. Preferred examples of the inorganic acid salts include aluminum chloride, aluminum sulfate, aluminum nitrate, zinc chloride, zinc sulfate, zinc nitrate, magnesium chloride, magnesium sulfate, magnesium nitrate, zirconium chloride, zirconium sulfate, and zirconium nitrate.

Preferred examples of the metallic alkoxides include aluminum alkoxide, titanium alkoxide, and zirconium alkoxide. Preferred examples of the metal complexes include aluminum acetylacetonate, aluminum ethyl acetoacetate, titanium acetylacetonate, and titanium ethyl acetoacetate.

Among these, a boron-containing compound, a phosphorus-containing compound, and an aluminum-containing compound (for example, boric acid, phosphoric acid, aluminum alkoxide, aluminum acetylacetonate, and the like) are preferred as a curing agent in view of water solubility and stability in water.

Examples of commercially available products thereof include ALUMINUM CHELATE A(W) (manufactured by Kawaken Fine Chemicals Co., Ltd.).

The curing agent is preferably uniformly mixed and dissolved in the coating liquid, and is preferably dissolved in water that is used as a solvent of a coating liquid for a protective layer in view of securing transparency of the resin base. The reason for this is that in a case where solubility in water is low, the curing agent is present as a solid in the coating liquid and remains as foreign matter after coating and drying, and as a result, transparency may be damaged.

In a case where the curing agent is contained, the amount of the curing agent is preferably in a range of 0.1 parts by mass to 20 parts by mass, more preferably in a range of 0.5 parts by mass to 10 parts by mass, and even more preferably in a range of 0.5 parts by mass to 8 parts by mass with respect to 100 parts by mass of an alkoxysilane (including a tetrafunctional alkoxysilane, and a trifunctional alkoxysilane and a bifunctional alkoxysilane).

As the curable component, for example, acrylic monomers such as KAYARAD (registered trademark) DPCA20 (manufactured by Nippon Kayaku Co., Ltd.) and various polyfunctional monomers may be used. For curing of the curable component, thermal curing or radiation curing by radiation such as ultraviolet light is suitable, and a commercially available polymerization initiator such as IRGACURE 184 (manufactured by BASF SE) may be added thereto.

In a case where the antistatic agent is contained, it is possible to impart an antistatic function to the decorative illumination ink jet recording material. As the antistatic agent, an ionic antistatic agent such as cation, anion, or betaine may be used, or particles of conductive metallic oxide such as tin oxide, indium oxide, zinc oxide, titanium oxide, magnesium oxide, or antimony oxide may be used.

The content of the antistatic agent can be adjusted such that the surface electrical resistance of the protective layer is within the following range.

The surface electrical resistance (23° C., relative humidity: 65%) of the protective layer is preferably 1.0—10¹² Ω/sq or less. In a case where the surface electrical resistance is within the above-described range, it is possible to prevent adhesion of foreign matter and ink scattering caused by charging by a roll contacting at the time of image recording. The surface roughness (23° C., relative humidity: 65%) of the protective layer is preferably 1.0×10¹² Ω/sq or less, and more preferably 1.0×10⁸ Ω/sq to 1.0×10¹² Ω/sq.

—Interlayer—

The decorative illumination ink jet recording material according to the embodiment of the invention may further have an interlayer between the resin base and the ink accepting layer. The interlayer functions to increase adhesion between the resin base and the ink accepting layer. The interlayer preferably has a modulus of elasticity of 500 MPa or less. The modulus of elasticity is more preferably 10 MPa to 500 MPa.

The interlayer can be formed using, for example, a resin such as an acrylic resin, polyester, or polyolefin. In addition, the interlayer is formed by curing a resin with a crosslinking agent contained therein, thereby further increasing the adhesion between the ink accepting layer and the resin base. The crosslinking agent may be an agent causing a crosslinking reaction during the formation of the interlayer, and preferred examples thereof include oxazoline-based compounds, carbodiimide-based compounds, epoxy-based compounds, isocyanate-based compounds, and melamine-based compounds.

—Other Layers—

The decorative illumination ink jet recording material according to the embodiment of the invention may have other layers in addition to the ink accepting layer and the protective layer as long as the actions and effects of the embodiment of the invention are not affected. For example, an antistatic layer, a refractive index adjustment layer, and the like may be provided as other layers. For example, a decorative illumination ink jet recording material having an ink accepting layer, a resin base, an antistatic layer, and a protective layer in this order is exemplified.

˜Method of Manufacturing Ink Jet Recording Material˜

The method of manufacturing a decorative illumination ink jet recording material according to the embodiment of the invention is not particularly limited, and the decorative illumination ink jet recording material can be produced by a method including: forming an ink accepting layer by coating one surface of a resin base with a coating liquid for an ink accepting layer and drying the surface; and forming a protective layer by coating the other surface with a coating liquid for a protective layer and drying the surface.

In this case, in a case where the ink accepting layer is formed to have a lamination structure of two or more layers or the protective layer is formed to have a lamination structure of two or more layers, the lamination structure can be formed by sequential coating or simultaneous multilayer coating with two or more types of coating liquids for an ink accepting layer or two or more types of coating liquids for a protective layer. In a case where an interlayer is further formed between the resin base and the ink accepting layer, one surface of the resin base is subjected to sequential coating or simultaneous multilayer coating with a coating liquid for an interlayer and a coating liquid for an ink accepting layer such that the layers are sequentially laminated, drying is performed thereon, and thus the interlayer and the ink accepting layer can be formed. If necessary, other steps may be further provided.

The coating can be performed through a known coating method using, for example, a blade coater, an air-knife coater, a roll coater, a bar coater, a gravure coater, a reverse coater, or the like. In a case where the coating is performed through simultaneous multilayer coating for simultaneous coating with a plurality of coating liquids without providing a drying step, the coating can be performed through a coating method using, for example, a slide bead coater, a slide curtain coater, a curtain flow coater, an extrusion die coater, or the like.

The amount of coating with the coating liquid used for formation of the ink accepting layer is preferably 3 g/m² to 30 g/m², and more preferably 5 g/m² to 20 g/m². Here, in a case where the interlayer is formed, the amount of coating with the coating liquid used for formation of the interlayer is preferably 3 g/m² to 30 g/m², and more preferably 5 g/m² to 20 g/m².

The amount of coating with the coating liquid used for formation of the protective layer is preferably 3 g/m² to 30 g/m², and more preferably 5 g/m² to 20 g/m².

<Decorative Illumination Image and Method of Forming Decorative Illumination Image>

A decorative illumination image according to the embodiment of the invention is an ink image formed using the decorative illumination ink jet recording material according to the embodiment of the invention. Since the decorative illumination ink jet recording material according to the embodiment of the invention is used, particularly, a light source image in a case where transmitted light enters is unlikely to be visually confirmed, and excellent clearness is obtained.

The decorative illumination image according to the embodiment of the invention may be formed by any method as long as the method uses the above-described decorative illumination ink jet recording material according to the embodiment of the invention. Particularly, the decorative illumination image is preferably an image formed by the method of forming a decorative illumination image according to the embodiment of the invention. That is,

a decorative illumination image is most preferably formed by a method of forming a decorative illumination image including a discharge step of discharging a radiation-curable ink composition (hereinafter, also simply referred to as “ink composition”) to form an image by an ink jet method on the above-described decorative illumination ink jet recording material according to the embodiment of the invention, and a curing step of curing the radiation-curable ink composition by irradiating the discharged radiation-curable ink composition with radiation.

Since the method of forming a decorative illumination image according to the embodiment of the invention uses the decorative illumination ink jet recording material according to the embodiment of the invention, a light source image shown in a case where transmitted light enters is unlikely to be visually confirmed, and a decorative illumination image that is clearly developed with any one of reflected light and transmitted light is obtained.

Wide format ink jet printer systems provided with an ink jet recording device are preferably used to form a decorative illumination image using the decorative illumination ink jet recording material according to the embodiment of the invention. Among these, a wide format UV ink jet printer system in which an image cured by ultraviolet (UV) irradiation is obtained is preferred.

The wide format ink jet printer system mentioned herein refers to a system that discharges an ink composition from the ink jet recording device and cures the discharged ink composition by radiation irradiation, and is suitable for producing large-sized recorded matter in a short period of time. Specifically, the white format ink jet printer system refers to a printer capable of recording an image having a width of 24 inches (0.61 m) or greater.

Examples of the wide format UV ink jet printer system include LuxelJet (registered trademark) UV360GTW/XTW and LuxelJet UV550GTW/XTW series, Acuity (registered trademark) LED 1600 (all manufactured by Fujifilm (registered trademark) Corporation), and inca SP320/SP320e/SP320S/SP320W (manufactured by Inca Digital Printers Limited).

—Discharge Step—

In the discharge step according to the embodiment of the invention, a radiation-curable ink composition is discharged to form an image by an ink jet method on a decorative illumination ink jet recording material. Specifically, it is possible to discharge the radiation-curable ink composition using an ink jet recording device using the ink jet method.

Examples of the ink jet recording device include a device including an ink supply system, a temperature sensor, and an active radiation source.

The ink supply system is provided with, for example, a piezo ink jet head that discharges an ink composition, a storage tank that stores an ink composition, a supply pipe that supplies an ink composition from the storage tank to the ink jet head, an ink supply tank that is disposed immediately before the ink jet head, and a filter.

The piezo ink jet head is preferably driven such that multi-size dots of 1 pl (picoliter; the same hereinafter) to 100 pl (more preferably 8 pl to 30 pl) are preferably discharged with a resolution of 320×320 to 4,000×4,000 dpi (dots per inch) (more preferably 400×400 to 1,600×1,600 dpi, and even more preferably 720×720 dpi). dpi indicates the number of dots per a length of 1 inch (2.54 cm).

The radiation-curable ink composition is not particularly limited, and a known composition that can be cured after discharge may be appropriately selected. Particularly, a solventless radiation-curable ink composition in which a polymerizable monomer component has a solvent function is preferred.

The radiation can impart energy that generates an active species promoting a curing reaction in the ink composition by irradiation, and includes α-rays, γ-rays, X-rays, ultraviolet rays, visible light rays, electron beams, and the like. Among these, ultraviolet rays and electron beams are preferred, and ultraviolet rays are particularly preferred from the viewpoint of curing sensitivity and availability of the device.

From such a viewpoint, the radiation-curable ink composition according to the embodiment of the invention is preferably an ultraviolet-curable ink composition.

Regarding the radiation-curable ink composition, the description in the paragraphs [0042] to [0052] of JP2010-47015A and JP1993-214280A (JP-H05-214280A) related to a non-conductive ink can be referred to. Regarding the solventless radiation-curable ink composition, the description in JP2004-131725A related to an ultraviolet-curable ink and JP2009-299057A related to an energy ray-curable ink jet ink composition can be referred to.

Regarding the radiation-curable ink composition, since ink droplets discharged are desirably kept at a constant temperature, the ink jet recording device is preferably provided with means for stabilizing the temperature of the ink composition. The portion in which the temperature is stabilized is a pipe system from the storage tank (also including an intermediate tank and the like in a case where the intermediate tank and the like are provided) that stores the ink composition to a discharge hole of the ink jet head. That is, thermal insulation and heating are preferably performed from the storage tank to the ink jet head.

The temperature control method is not particularly limited. For example, a temperature sensor is preferably provided in the storage tank, the ink jet head, and the respective pipes to control the heating according to the flow rate of the ink composition and the environmental temperature.

The ink composition is preferably discharged after being heated preferably to 25° C. to 80° C., and more preferably to 25° C. to 50° C. In this case, the viscosity of the ink composition can be adjusted to a range of 3 mPa·s to 15 mPa·s. The ink composition is preferably discharged after the viscosity of the ink composition is lowered to 3 mPa·s to 13 mPa·s. From the viewpoint of more satisfactorily performing the discharge, an ink composition having a viscosity of 50 mPa·s or less at 25° C. is preferably used. Here, the viscosity can be measured using a general viscometer, and is a value measured using, for example, a vibration-type viscometer (DV−II+VISCOMETER manufactured by BROOKFIELD AMETEK) and a cone plate (φ35 mm) under the environment of a temperature of 25° C. and a relative humidity of 50%.

Excellent discharge stability is obtained by adjusting the viscosity as described above.

Since the radiation-curable ink composition has a higher viscosity than an aqueous ink that is generally used as an ink jet recording ink, the viscosity change due to the temperature change at the time of discharge may be easily affected, the viscosity change may largely affects a change of liquid droplet size and a change of liquid droplet discharge rate, and eventually, image quality may be damaged. Therefore, it is desirable that the temperature of the ink composition at the time of discharge is stably maintained. In the embodiment of the invention, the temperature control width of the ink composition is preferably set temperature±5° C., more preferably set temperature±2° C., and even more preferably set temperature±1° C.

—Curing Step—

In the curing step according to the embodiment of the invention, the radiation-curable ink composition discharged on the decorative illumination ink jet recording material (for example, in the form of a sheet) in the discharge step is irradiated with radiation to cure the radiation-curable ink composition. Accordingly, a cured image is obtained.

In a case where the radiation-curable ink composition contains a radical polymerization initiator, the radical polymerization initiator is decomposed by radiation irradiation, and thus a radical is generated, and a polymerization reaction of the polymerizable monomer component is carried out and promoted by the generated radical. At this time, in a case where a sensitizer is present together with the radical polymerization initiator in the ink composition, the sensitizer in the system is put into an excited state by absorbing the radiation, and can promote decomposition of the radical polymerization initiator by being brought into contact with the radical polymerization initiator to allow a curing reaction to proceed with higher sensitivity.

Although depending on absorption characteristics of the components contained in the ink composition, the peak wavelength of the radiation is, for example, preferably 200 nm to 600 nm, more preferably 300 nm to 450 nm, and even more preferably 350 nm to 420 nm.

The illuminance of the radiation is preferably 10 mW/cm² to 4,000 mW/cm², and more preferably 20 mW/cm² to 2,500 mW/cm².

As the radiation source, a mercury lamp, a metal halide lamp, a gas laser, a solid laser, or the like can be used. A GaN-based semiconductor laser is preferred from the viewpoint of environmental protection by removal of mercury, and a light-emitting diode (LED; for example, ultraviolet LED (UV-LED)) or a laser diode (LD; for example, ultraviolet LD (UV-LD)) is preferred from the viewpoint of small size, long lifetime, high efficiency, and low cost.

For example, a LED having a main emission spectrum between 365 nm and 420 nm, manufactured by NICHIA CORPORATION, or a LED capable of emitting radiation centered on the wavelength between 300 nm and 370 nm, described in U.S. Pat. No. 6,084,250A, can be used.

In the embodiment of the invention, as the radiation source, a UV-LED is preferred, and a UV-LED having a peak wavelength in a range of 350 nm to 420 nm is particularly preferred.

In a case where a LED is used, the maximum illuminance of the surface of the recording material by the LED is preferably 1 mW/cm² to 2,000 mW/cm², more preferably 20 mW/cm² to 1,000 mW/cm², and particularly preferably 50 mW/cm² to 800 mW/cm².

In the curing step, the ink composition is preferably irradiated with radiation for 0.01 seconds to 120 seconds, and more preferably for 0.1 seconds to 90 seconds.

Regarding the radiation irradiation conditions and radiation irradiation method, the description in JP1985-132767A (JP-S60-132767A) can be referred to. Specifically, for example, in a so-called shuttle-type device, a light source is provided on each of both sides of a head unit in the device, and the head unit and the light sources are scanned to perform the radiation irradiation.

The radiation irradiation is performed after a certain period of time (preferably 0.01 seconds to 0.5 seconds, more preferably 0.01 seconds to 0.3 seconds, and even more preferably 0.01 seconds to 0.15 seconds) since the ink composition is landed on the ink jet recording material. In a case where the period of time from the landing of the ink composition to the radiation irradiation is controlled to be a short period of time, it is possible to prevent a phenomenon in which the ink composition landed on the ink jet recording material bleeds before being cured.

As the radiation-curable ink composition, an ink set provided with a plurality of colors of ink compositions may be used. For example, an ink set consisting of four colors of ink compositions obtained by combining a yellow ink composition, a cyan ink composition, a magenta ink composition, and a black ink composition may be used. Using such an ink set provided with four colors of ink compositions, a full color image can be obtained.

An ink set provided with five colors of ink compositions of yellow, cyan, magenta, black, and white and two colors of ink compositions of light cyan and light magenta is more preferred.

In order to form a color image, images of respective colors are preferably superimposed by using and discharging the respective color ink compositions in order from an ink composition having a color with lower brightness than other colors. Specifically, in a case where an ink set provided with four colors of ink compositions of yellow, cyan, magenta, and black is used, the ink compositions are preferably discharged to the ink jet recording material in order of yellow, cyan, magenta, and black.

In a case where an ink set provided with total seven colors of ink compositions including two colors of ink compositions of light cyan and light magenta and five colors of ink compositions of cyan, magenta, black, white, and yellow is used, the ink compositions are preferably discharged to the ink jet recording material in order of white, light cyan, light magenta, yellow, cyan, magenta, and black.

By superimposing the images of respective colors in order from an ink composition with low brightness as described above, radiation easily reaches the ink composition positioned close to the resin base. Accordingly, good curing sensitivity, reduction of residual monomers, and an improvement in adhesiveness of the image are expected.

The radiation irradiation may be collectively performed after discharge of all of the desired color ink compositions. Radiation irradiation may be performed for each color from the viewpoint of promotion of curing.

The thickness of the decorative illumination image is preferably 1 μm to 800 μm, more preferably 100 μm to 800 μm, and even more preferably 500 μm to 750 μm.

The width of the decorative illumination image is not particularly limited. From the viewpoint that the image is preferably recorded by a wide format ink jet printer system, the width is preferably 0.3 m to 5 m, more preferably 0.5 m to 4 m, and particularly preferably 1 m to 3 m.

A preferred width of the decorative illumination ink jet recording material is the same as that of the above-described decorative illumination image.

<Decorative Illumination Signboard>

A decorative illumination signboard according to the embodiment of the invention is provided with a light source and the above-described decorative illumination image according to the embodiment of the invention. Since the decorative illumination signboard according to the embodiment of the invention has a decorative illumination image formed using the decorative illumination ink jet recording material according to the embodiment of the invention, a light source image is unlikely to be visually confirmed, and a clear decorative illumination image is displayed.

In the decorative illumination signboard, the decorative illumination ink jet recording material on which the decorative illumination image is recorded is preferably installed such that a side opposite to the side having the ink accepting layer when viewed from the resin base, that is, a side having the protective layer is a visual confirmation side. That is, the light source is preferably disposed on the ink accepting layer side of the decorative illumination ink jet recording material according to the embodiment of the invention, and the decorative illumination image is preferably visually confirmed through the resin base from the protective layer side.

For example, a damage resistant layer described in WO2009/001629A, a hard coat layer with antistatic performance described in JP1993-186534A (JP-H05-186534A), an anti-glare layer described in JP1989-46701A (JP-H01-46701A), an anti-reflective layer described in JP2001-330708A, a weather resistant layer described in JP2011-146659A, and the like may be provided on a side of the resin base on the side having the protective layer. In addition, various films having damage resistance, anti-glare properties, and the like may be laminated on the side of the resin base on the side having the protective layer.

The decorative illumination image in the decorative illumination signboard is preferably disposed between transparent acrylic resins or the like.

The light source is not particularly limited, and for example, a light bulb, a fluorescent lamp, a light-emitting diode (LED), an electroluminescent panel (ELP), one or more cold-cathode fluorescent lamps (CCFL), a hot-cathode fluorescent lamp (HCFL), or the like can be used.

### EXAMPLES

Hereinafter, the embodiments of the invention will be described in more detail using examples, but the invention is not limited to the following examples as long as it does not depart from the gist of the invention. Unless specifically noted, the “part” is based on the mass.

### Example 1

[Production of Support]

A polyethylene terephthalate (hereinafter, referred to as “PET”) resin polycondensed using a Sb compound as a catalyst was dried such that the moisture content thereof was reduced to 50 ppm or less. Then, this PET resin was supplied to an extruder having a heater temperature set to 280° C. to 300° C., and melted and kneaded. The melted and kneaded PET resin was discharged on an electrostatically charged chill roll from a die portion to obtain an amorphous PET sheet. Next, the obtained amorphous PET sheet was stretched by 3.1 times in a traveling direction (MD; machine direction) of the sheet, and then stretched by 3.8 times in a width direction (TD; transverse direction) to obtain a PET support (resin base) having a thickness of 180

[Production of Ink Jet Recording Material]

The PET support was subjected to a corona discharge treatment under the condition of 730 J/m², and then the corona-treated surface thereof was coated with the following coating liquid A for an ink accepting layer by a bar coating method such that the amount of TiO₂ applied was 3.5 g/m², thereby forming a coating film. By drying this coating film for 1 minute at 160° C., an ink accepting layer 21 having a dry film thickness of 3.5 μm was formed on one side of the PET support.

After a corona discharge treatment was performed on the PET support on a side opposite to the side having the ink accepting layer 21, the following coating liquid B for a protective layer was coated thereon by a bar coating method under the condition of 310 J/m² such that the amount of the acrylic resin (PMMA) particles applied was 0.2 g/m². By drying this coating film for 1 minute at 160° C., a protective layer 31 having a dry film thickness of 1.0 μm was formed on the other side of the PET support.

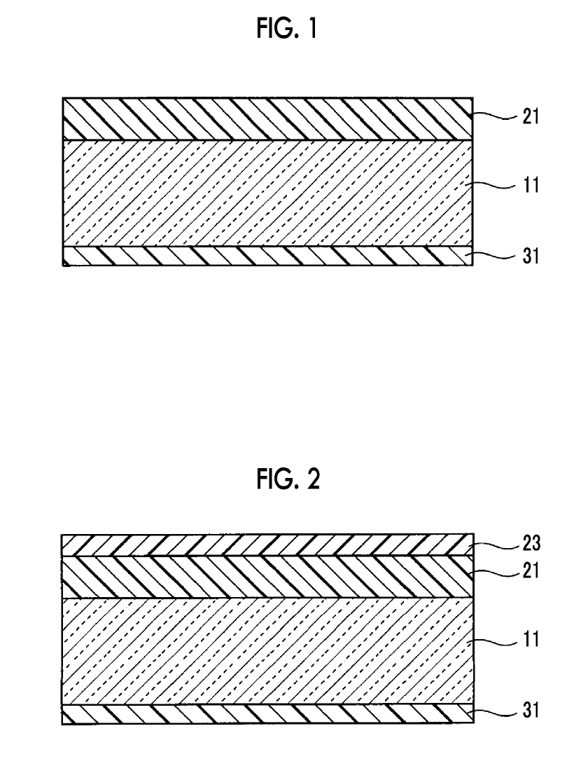

In this manner, a decorative illumination ink jet recording material having a three-layer structure illustrated in the cross-sectional view of FIG. 1, that is, an ink jet recording material (a decorative illumination ink jet recording material having a three-layer configuration of ink accepting layer 21/resin base 11/protective layer 31) having the ink accepting layer 21 on one surface of the PET support that was the resin base 11, and the protective layer 31 on the other surface was produced.

—Production of Coating Liquid A for Ink Accepting Layer—

(1) Preparation of Titanium Dioxide Dispersion Liquid

The following components in the composition were mixed, and the mixture was subjected to a dispersion treatment for 1 hour using a dyno mill-type disperser to prepare a dispersion liquid. The composition of the dispersion liquid are as follows.

<Composition>

Titanium Dioxide (white pigment, average primary particle diameter: 0.3 μm): 465.0 parts

(TIPAQUE (registered trademark) CR-95 manufactured by ISHIHARA SANGYO KAISHA, LTD., solid content: 100 mass %)

Polyvinyl Alcohol: 233.0 parts

(PVA-105 manufactured by KURARAY CO., LTD., solid content: 10 mass %)

Surfactant: 5.6 parts

(DEMOL (registered trademark) EP manufactured by Kao Corporation, solid content: 25 mass %)

Preservative: 3.1 parts

(1,2-benzothiazoline-3-on manufactured by DAITO CHEMICAL CO., LTD., methanol solvent having a solid content of 3.5 mass %)

Distilled Water: The amount thereof was adjusted such that the total amount of the coating liquid A became 1,000 parts.

(2) Preparation of Coating Liquid A for Ink Accepting Layer

Using the above-described titanium dioxide dispersion liquid, the coating liquid A for an ink accepting layer having the following composition was prepared. The composition of the coating liquid A for an ink accepting layer are as follows.

<Composition of Coating Liquid A for Ink Accepting Layer>

Titanium Dioxide Dispersion Liquid: 288.3 parts

Polyolefin (binder resin): 417.6 parts

(ARROWBASE (registered trademark) SE-1013N manufactured by UNITIKA LTD., solid content: 20 mass %)

Acrylic Resin (binder resin): 33.5 parts

(AS-563A manufactured by DAICEL FINECHEM LTD., solid content: 28 mass %)

Crosslinking Agent (oxazoline-based compound): 93.7 parts

(EPOCROS (registered trademark) WS-700 manufactured by NIPPON SHOKUBAI CO., LTD., solid content: 25 mass %)

Catalyst: 7.3 parts

(manufactured by Nippon Chemical Industrial CO., LTD., 35 mass % solution of ammonium secondary phosphate for food additive)

Surfactant: 4.0 parts

(2 mass % solution of sodium 1,2-[bis(3,3,4,4,5,5,6,6,6-nonafluorohexylcarbonyl)]ethanesulfonate)

Distilled Water: The amount thereof was adjusted such that the total amount of the coating liquid A became 1,000 parts.

(3) Preparation of Coating Liquid B for Protective Layer

Next, the coating liquid B for a protective layer having the following composition was prepared. Specifically, while an acetic acid aqueous solution was strongly stirred in a constant-temperature tank at 25° C., 3-glycidoxypropyltriethoxysilane was added dropwise to this acetic acid aqueous solution over 3 minutes. After stirring for 1 hour, a tetraethoxysilane was added over 5 minutes to the acetic acid aqueous solution in the constant-temperature tank at 30° C. while being strongly stirred. Thereafter, the stirring was continued for 2 hours. The cooling to 10° C. was performed over 1 hour, and an aqueous solution (hereinafter, referred to as an aqueous solution X) was obtained. Separately from this, a curing agent, surfactants A and C, distilled water, and acrylic resin particles were mixed and subjected to ultrasonic dispersion for 5 minutes to obtain a particle dispersion liquid (hereinafter, referred to as an aqueous solution Y). The aqueous solution Y, surfactants A and C, and distilled water were sequentially added to the obtained aqueous solution X, and then cooled to 10° C. In this manner, the coating liquid B for a protective layer was prepared.

<Composition of Coating Liquid B for Protective Layer>

Acetic Acid Aqueous Solution: 402.0 parts

(manufactured by Daicel Corporation, 1 mass % aqueous solution of industrial acetic acid)

3-Glycidoxypropyltriethoxysilane: 110.0 parts

(KBE-403 manufactured by Shin-Etsu Chemical Co., Ltd.)

Tetraethoxysilane: 127.6 parts

(KBE-04 manufactured by Shin-Etsu Chemical Co., Ltd.)

Curing Agent: 1.3 parts

(ALUMINUM CHELATE A(W) manufactured by Kawaken Fine Chemicals Co., Ltd.)

Surfactant C: 14.7 parts

(manufactured by Sanyo Chemical Industries, Ltd., 10% aqueous solution of SANDEDDO (registered trademark) BL, anionic)

Surfactant A: 40.9 parts

(manufactured by Sanyo Chemical Industries, Ltd., 1 mass % aqueous solution of NAROACTY (registered trademark) CL-95, nonionic)

Acrylic Resin (PMMA) Particles (transparent particles): 9.2 parts

(MX-150 (crosslinked PMMA) manufactured by Soken Chemical & Engineering Co., Ltd., average primary particle diameter: 1.5 μm)

Acrylic Resin (PMMA) Particles (transparent particles): 9.2 parts

(MX-80H3WT (highly crosslinked PMMA) manufactured by Soken Chemical & Engineering Co., Ltd., average primary particle diameter: 0.8 μm)

Distilled Water: The amount thereof was adjusted such that the total amount of the coating liquid B became 1,000 parts.

[Evaluation]

—1. Evaluation Before Recording—

(a) Diffuse Transmittance

Using a device in which an integrating sphere attachment device ISR-2200 was attached to a spectrophotometer UV-2450 (manufactured by Shimadzu Corporation), a diffuse transmittance of the ink jet recording material with respect to light with a wavelength of 550 nm was measured. The measurement was performed under the condition that light entered from the PET support on the side opposite to the side having the ink accepting layer. Based on the measured diffuse transmittance, evaluation was performed according to the following evaluation standard. Levels A to C were evaluated to be acceptable.

<Evaluation Standard>

A: The diffuse transmittance is 40% to less than 60%.

B: The diffuse transmittance is 30% to less than 40% or 60% to less than 70%.

C: The diffuse transmittance is 25% to less than 30% or 70% to less than 75%.

D: The diffuse transmittance is 20% to less than 25% or 75% to less than 80%.

E: The diffuse transmittance is less than 20% or 80% or greater.

—2. Evaluation After Recording—

Using “wide format UV ink jet press Luxel Jet (registered trademark) UV550GTW”, manufactured by Fujifilm (registered trademark) Corporation, as a recording device, a color image was formed by two times of recording on the ink accepting layer side of the ink jet recording material using the following ink under the following conditions. In this manner, A2-size recorded matter (decorative illumination sheet) was obtained. The thickness of the image after drying was 500 μm to 720 μm.

Solventless Radiation-Curable Ink: manufactured by FUJIFILM Speciality Ink System Limited, Product Number: UVIJET (registered trademark, the same hereinafter) KO 021 White, UVIJET KO 004 Black, UVIJET KO 215 Cyan, UVIJET KO 867 Magenta, UVIJET KO 052 Yellow

<Conditions>

Irradiation Wavelength: 365 nm to 405 nm

Recording Speed: 22 m/hr

(Image Clearness)

The above-described decorative illumination sheet (the sheet-shaped ink jet recording material with the color image output thereon) was put on an evaluation stand and irradiated with light from a ceiling lamp installed above the decorative illumination sheet to perform visual evaluation according to the following evaluation standard. Levels A to C were judged to be acceptable.

The ceiling lamp was used as a diffused light source of which the lamp outline was not shown in a case of viewing the ceiling lamp through the ink jet recording material.

<Evaluation Standard>

A: The color of the image is clearly shown.

B: The black portion in the image is slightly whitened.

C: The respective colors in the image are slightly whitened.

D: The whitening of the black portion in the image is clearly shown.

E: The whole image is whitened, and the contrast thereof is lowered.

(b) Light Source Image (Lamp Image)

The above-described decorative illumination sheet (the sheet-shaped ink jet recording material with the color image output thereon) was put on a LED internal lighting panel (FE999 manufactured by Belk co., ltd.) in which an acrylic opaque panel was detached therefrom. The decorative illumination sheet was visually observed from a place separated by 2 m from the decorative illumination sheet to evaluate the degree of visual confirmation of a light source image (lamp image) according to the following evaluation standard. Levels A to C were judged to be acceptable.

<Evaluation Standard>

A: The light source is not recognized.

B: The light source is blurred and the number of LEDs cannot be counted.

C: The light source is blurred, but the number of LEDs can be counted.

D: The outline is blurred, but the center portion of the light source is clearly shown.

E: The outline of the light source is clearly shown.

(c) Ink Adhesion Immediately After Image Formation

On recorded matter immediately after an image was output thereon, 11 straight scratches were formed using a single-edged razor blade in each of horizontal and vertical directions at intervals of 5 mm in a lattice form to form 100 squares, each of which had a size of 5 mm in each of horizontal and vertical directions. Next, an adhesive tape (600 manufactured by 3M Limited) was adhered to a surface of the recorded matter on which 100 squares were formed. After complete adhesion by rubbing the adhesive tape using an eraser, the adhesive tape was peeled off in a direction vertical to the surface of the recorded matter to obtain the number of squares peeled off from the ink accepting layer. Based on the obtained number, the strength of adhesion to ink was evaluated according to the following evaluation standard. Levels A and B were judged to be acceptable.

<Evaluation Standard>

A: No peeling occurs

B: The number of squares peeled is 1 to less than 5.

C: The number of squares peeled is 5 to less than 15.

D: The number of squares peeled is 15 to less than 30.

E: The number of squares peeled is 30 or greater.

### Examples 2 to 7

An ink jet recording material was produced in the same manner as in Example 1, except that regarding the coating liquid A for an ink accepting layer and the coating liquid B for a protective layer of Example 1, the particles and the contents of particles were changed as shown in the following Table 1, and evaluation was performed in the same manner.

### Example 8

An ink jet recording material was produced in the same manner as in Example 1, except that in Example 1, the particles and the contents of particles used in the coating liquid A for an ink accepting layer and the coating liquid B for a protective layer were changed as shown in the following Table 1, and the resin base was replaced with white polyethylene terephthalate (white PET) in which a titanium oxide was kneaded by melting and kneading a PET resin together with the titanium oxide in an amount shown in the following Table 1, and evaluation was performed in the same manner.

### Example 9

An ink accepting layer 21 was formed in the same manner as in Example 1 on one side of the PET support produced in Example 1, except that the type of particles and the contents of particles were changed in the coating liquid A for an ink accepting layer of Example 1. Next, a corona discharge treatment was performed under the condition of 310 J/m² on the PET support on a side opposite to the side having the ink accepting layer 21, and then the following coating liquid C for a protective layer was coated thereon by a bar coating method such that the amount of the particles applied was as shown in Table 1, thereby forming a coating film. By drying this coating film for 1 minute at 160° C., a protective layer 1 was formed on the other side of the PET support.

(Preparation of Coating Liquid C for Protective Layer)

Components in the following composition were mixed together to prepare a coating liquid C for a protective layer.

<Composition of Coating Liquid C for Protective Layer>

Self-Crosslinking Polyurethane Resin Binder: 31.5 parts

(TAKELAC WS-5100 manufactured by Mitsui Chemicals, Inc., solid content: 30 mass %)

Aqueous Dispersion of Tin Dioxide-Antimony Composite Acicular Metal Oxide (transparent particles): 43.7 parts

(FS-10D manufactured by ISHIHARA SANGYO KAISHA, LTD., solid content: 20 mass %)

Surfactant C: 2.1 parts

(manufactured by Sanyo Chemical Industries, Ltd., 10 mass % aqueous solution of SANDEDDO (registered trademark) BL, anionic)

Surfactant A: 21.0 parts

(manufactured by Sanyo Chemical Industries, Ltd., 1 mass % aqueous solution of NAROACTY (registered trademark) CL-95, nonionic)

Distilled Water: The amount thereof was adjusted such that the total amount of the coating liquid C became 1,000 parts.

Next, the surface of the ink accepting layer 21 formed in the above description was subjected to a corona discharge treatment under the condition of 200 J/m², and then a coating liquid D for an ink accepting layer was coated thereon by a bar coating method such that the amount of the polystyrene (PS) particles applied was 0.05 g/m². The coating liquid was dried for 1 minute at 160° C. to laminate an ink accepting layer 23 on the ink accepting layer 21. At this time, the coating amount was adjusted such that the ink accepting layer 23 had a dry film thickness of 0.5 μm.

In this manner, a decorative illumination ink jet recording material having a four-layer structure illustrated in the cross-sectional view of FIG. 2, that is, an ink jet recording material (a decorative illumination ink jet recording material having a four-layer configuration of ink accepting layer 23/ink accepting layer 21/resin base 11/protective layer 31) having the ink accepting layer 21 and the ink accepting layer 23 on one surface of the PET support that was the resin base 11, and the protective layer 31 on the other surface was produced.

Using the obtained ink jet recording material, evaluation was performed in the same manner as in Example 1.

(Preparation of Coating Liquid D for Ink Accepting Layer)

Components in the following composition were mixed together to prepare a coating liquid D for an ink accepting layer.

<Composition of Coating Liquid D for Ink Accepting Layer>

Aqueous Dispersion Liquid of Polystyrene (PS) Latex (transparent particles): 35.7 parts

(Nipol UFN1008 manufactured by ZEON Corporation, solid content: 20 mass %)

Polyester Resin (binder resin): 113.7 parts

(PLASCOAT Z592 manufactured by GOO CHEMICAL CO., LTD., solid content: 25 mass %)

Polyurethane Resin (binder resin): 74.8 parts

(SUPERFLEX (registered trademark) 150HS manufactured by DKS Co., Ltd., solid content: 38 mass %)

Crosslinking Agent (oxazoline-based compound): 10.1 parts

(EPOCROS (registered trademark) K-2020E manufactured by NIPPON SHOKUBAI CO., LTD., solid content: 40 mass %)

Surfactant A: 39.4 parts

(manufactured by Sanyo Chemical Industries, Ltd., 1 mass % aqueous solution of NAROACTY (registered trademark) CL-95)

Surfactant B: 16.3 parts

(manufactured by NOF CORPORATION, 1 mass % aqueous solution of RAPISOL (registered trademark) B-90)

Lubricant: 2.2 parts

(carnauba wax dispersion CELLOSOL (registered trademark) 524 manufactured by CHUKYO YUSHI CO., LTD., solid content: 30 mass %)

Preservative: 1.0 part

(1,2-benzothiazoline-3-on manufactured by DAITO CHEMICAL CO., LTD., methanol solvent having a solid content of 3.5 mass %)

Distilled Water: The amount thereof was adjusted such that the total amount of the coating liquid D became 1,000 parts.

### Example 10

Using the coating liquid A for an ink accepting layer of Example 1, an ink accepting layer 21 was formed in the same manner as in Example 1 on one side of the PET support produced in Example 1. Next, a corona discharge treatment was performed under the condition of 310 J/m² on the PET support on a side opposite to the side having the ink accepting layer 21, and then a coating liquid C for a protective layer that was the same as that in Example 9 was coated thereon in the same manner as in Example 9 by a bar coating method to form a coating film. Thereafter, this coating film was dried for 1 minute at 160° C. to form a protective layer 31 on the other side of the PET support.

Next, the surface of the protective layer 31 formed as described above was subjected to a corona discharge treatment under the condition of 200 J/m², and then the following coating liquid E for a protective layer was coated thereon by a bar coating method such that the amount of the PMMA particles and the amount of the polystyrene (PS) particles applied were 0.1 g/m², respectively. The coating liquid was dried for 1 minute at 160° C. to laminate a protective layer 33 on the protective layer 31. At this time, the coating amount was adjusted such that the protective layer 33 had a dry film thickness of 1.0 μm.

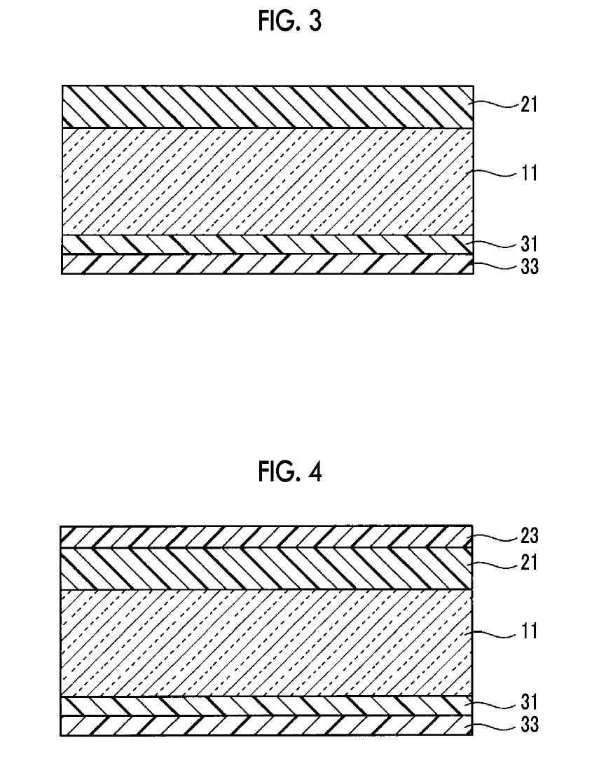

In this manner, a decorative illumination ink jet recording material having a four-layer structure illustrated in the cross-sectional view of FIG. 3, that is, an ink jet recording material (a decorative illumination ink jet recording material having a four-layer configuration of ink accepting layer 21/resin base 11/protective layer 31/protective layer 33) having the ink accepting layer 21 on one surface of the PET support that was the resin base 11, and the protective layer 31 and the protective layer 33 on the other surface was produced.

Using the obtained ink jet recording material, evaluation was performed in the same manner as in Example 1.

(Preparation of Coating Liquid E for Protective Layer)

Components in the following composition were mixed together to prepare a coating liquid E for a protective layer.

<Composition of Coating Liquid E for Protective Layer>

Acetic Acid Aqueous Solution: 402.0 parts

(manufactured by Daicel Corporation, 1 mass % aqueous solution of industrial acetic acid)

3-Glycidoxypropyltriethoxysilane: 110.0 parts

(KBE-403 manufactured by Shin-Etsu Chemical Co., Ltd.)

Tetraethoxysilane: 127.6 parts

(KBE-04 manufactured by Shin-Etsu Chemical Co., Ltd.)

Curing Agent: 1.3 parts

(ALUMINUM CHELATE A(W) manufactured by Kawaken Fine Chemicals Co., Ltd.)

Surfactant C: 14.7 parts

(manufactured by Sanyo Chemical Industries, Ltd., 10% aqueous solution of SANDEDDO (registered trademark) BL, anionic)

Surfactant A: 40.9 parts

(manufactured by Sanyo Chemical Industries, Ltd., 1 mass % aqueous solution of NAROACTY (registered trademark) CL-95, nonionic)

Acrylic Resin (PMMA) Particles (transparent particles): 9.2 parts

(MX-150 (crosslinked PMMA) manufactured by Soken Chemical & Engineering Co., Ltd., average primary particle diameter: 1.5 μm)

Aqueous Dispersion Liquid of Polystyrene Latex (transparent particles): 9.2 parts

(Nipol UFN1008 manufactured by ZEON Corporation, solid content: 20 mass %)

Distilled Water: The amount thereof was adjusted such that the total amount of the coating liquid E became 1,000 parts.

### Example 11

A decorative illumination ink jet recording material having a five-layer structure illustrated in the cross-sectional view of FIG. 4, that is, an ink jet recording material (a decorative illumination ink jet recording material having a five-layer configuration of ink accepting layer 23/ink accepting layer 21/resin base 11/protective layer 31/protective layer 33) having the ink accepting layer 21 and the ink accepting layer 23 on one surface of the PET support that was the resin base 11, and the protective layer 31 and the protective layer 33 on the other surface was produced in the same manner as in Example 10, except that in Example 10, the particles used in the coating liquid A for an ink accepting layer and the content of particles were changed as shown in the following Table 1, and the ink accepting layer 23 was laminated on the ink accepting layer 21 as described above.

Using the obtained ink jet recording material, evaluation was performed in the same manner as in Example 1.

(Formation of Ink Accepting Layer 23)

The surface of the ink accepting layer 21 on the PET support was subjected to a corona discharge treatment under the condition of 200 J/m², and then the following coating liquid F for an ink accepting layer was coated thereon by a bar coating method such that the dry film thickness was 0.5 μm. The coating liquid was dried for 1 minute at 160° C. to laminate an ink accepting layer 23 on the ink accepting layer 21. The coating liquid F for an ink accepting layer was prepared by mixing components in the following composition.

<Composition of Coating Liquid F for Ink Accepting Layer>

Polyester Resin (binder resin): 113.7 parts

(PLASCOAT Z592 manufactured by GOO CHEMICAL CO., LTD., solid content: 25 mass %)

Polyurethane Resin (binder resin): 74.8 parts

(SUPERFLEX (registered trademark) 150HS manufactured by DKS Co., Ltd., solid content: 38 mass %)

Crosslinking Agent (oxazoline-based compound): 10.1 parts

(EPOCROS (registered trademark) K-2020E manufactured by NIPPON SHOKUBAI CO., LTD., solid content: 40 mass %)

Surfactant A: 39.4 parts

(manufactured by Sanyo Chemical Industries, Ltd., 1 mass % aqueous solution of NAROACTY (registered trademark) CL-95)

Surfactant B: 16.3 parts

(manufactured by NOF CORPORATION, 1 mass % aqueous solution of RAPISOL (registered trademark) B-90)

Lubricant: 2.2 parts

(carnauba wax dispersion CELLOSOL (registered trademark) 524 manufactured by CHUKYO YUSHI CO., LTD., solid content: 30 mass %)

Preservative: 1.0 part

(1,2-benzothiazoline-3-on manufactured by DAITO CHEMICAL CO., LTD., methanol solvent having a solid content of 3.5 mass %)

Distilled Water: The amount thereof was adjusted such that the total amount of the coating liquid D became 1,000 parts.

### Example 12

An ink accepting layer 21 was formed in the same manner as in Example 1 on one side of the PET support produced in Example 1, except that the content of particles was changed in the coating liquid A for an ink accepting layer of Example 1. Next, a corona discharge treatment was performed under the condition of 310 J/m² on the PET support on a side opposite to the side having the ink accepting layer 21, and then a protective layer 31 was formed on the other side of the PET support in the same manner as in Example 9, except that the particles and the contents of particles were changed in the coating liquid C for a protective layer of Example 9.

Next, the surface of the ink accepting layer 21 formed in the above description was subjected to a corona discharge treatment under the condition of 200 J/m², and then the following coating liquid G for an ink accepting layer was coated thereon by a bar coating method such that the amount of the PMMA particles applied was 0.1 g/m². The coating liquid was dried for 1 minute at 160° C. to laminate an ink accepting layer 23 on the ink accepting layer 21.

The coating liquid G for an ink accepting layer was prepared by mixing components in the following composition, and the amount of coating with the coating liquid G for an ink accepting layer was adjusted such that the ink accepting layer 23 had a dry film thickness of 0.5 μm.

Next, the surface of the protective layer 31 formed in the above description was subjected to a corona discharge treatment under the condition of 200 J/m², and then the following coating liquid H for a protective layer was coated thereon by a bar coating method such that the amount of the PMMA particles applied was 0.1 g/m². The coating liquid was dried for 1 minute at 160° C. to laminate a protective layer 33 on the protective layer 31.

The coating liquid H for a protective layer was prepared by mixing components in the following composition, and the amount of coating with the coating liquid H for a protective layer was adjusted such that the protective layer 33 had a dry film thickness of 0.5 μm.

In this manner, a decorative illumination ink jet recording material having a five-layer structure illustrated in the cross-sectional view of FIG. 4, that is, an ink jet recording material (a decorative illumination ink jet recording material having a five-layer configuration of ink accepting layer 23/ink accepting layer 21/resin base 11/protective layer 31/protective layer 33) having the ink accepting layer 21 and the ink accepting layer 23 on one surface of the PET support that was the resin base 11, and the protective layer 31 and the protective layer 33 on the other surface was produced.

Using the obtained ink jet recording material, evaluation was performed in the same manner as in Example 1.

<Composition of Coating Liquid G for Ink Accepting Layer>

Acrylic Resin (PMMA) Particles (transparent particles): 9.2 parts

(MX-150 (crosslinked PMMA) manufactured by Soken Chemical & Engineering Co., Ltd., average primary particle diameter: 1.5 μm)

Polyester Resin (binder resin): 113.7 parts

(PLASCOAT Z592 manufactured by GOO CHEMICAL CO., LTD., solid content: 25 mass %)

Polyurethane Resin (binder resin): 74.8 parts

(SUPERFLEX (registered trademark) 150HS manufactured by DKS Co., Ltd., solid content: 38 mass %)

Crosslinking Agent (oxazoline-based compound): 10.1 parts

(EPOCROS (registered trademark) K-2020E manufactured by NIPPON SHOKUBAI CO., LTD., solid content: 40 mass %)

Surfactant A: 39.4 parts

(manufactured by Sanyo Chemical Industries, Ltd., 1 mass % aqueous solution of NAROACTY (registered trademark) CL-95)

Surfactant B: 16.3 parts

(manufactured by NOF CORPORATION, 1 mass % aqueous solution of RAPISOL (registered trademark) B-90)

Lubricant: 2.2 parts

(carnauba wax dispersion CELLOSOL (registered trademark) 524 manufactured by CHUKYO YUSHI CO., LTD., solid content: 30 mass %)

Preservative: 1.0 part

(1,2-benzothiazoline-3-on manufactured by DAITO CHEMICAL CO., LTD., methanol solvent having a solid content of 3.5 mass %)

Distilled Water: The amount thereof was adjusted such that the total amount of the coating liquid G became 1,000 parts.

<Composition of Coating Liquid H for Protective Layer>

Acetic Acid Aqueous Solution: 402.0 parts

(manufactured by Daicel Corporation, 1 mass % aqueous solution of industrial acetic acid)

3-Glycidoxypropyltriethoxysilane: 110.0 parts

(KBE-403 manufactured by Shin-Etsu Chemical Co., Ltd.)

Tetraethoxysilane: 127.6 parts

(KBE-04 manufactured by Shin-Etsu Chemical Co., Ltd.)

Curing Agent: 1.3 parts

(ALUMINUM CHELATE A(W) manufactured by Kawaken Fine Chemicals Co., Ltd.)

Surfactant C: 14.7 parts

(manufactured by Sanyo Chemical Industries, Ltd., 10% aqueous solution of SANDEDDO (registered trademark) BL, anionic)

Surfactant A: 40.9 parts

(manufactured by Sanyo Chemical Industries, Ltd., 1 mass % aqueous solution of NAROACTY (registered trademark) CL-95, nonionic)

Acrylic Resin (PMMA) Particles (transparent particles): 9.2 parts

(MX-150 (crosslinked PMMA) manufactured by Soken Chemical & Engineering Co., Ltd., average primary particle diameter: 1.5 μm)

Distilled Water: The amount thereof was adjusted such that the total amount of the coating liquid H became 1,000 parts.

### Comparative Example 1

An ink jet recording material was produced in the same manner as in Example 1, except that in Example 1, the amount of the particles applied in the coating liquid A for an ink accepting layer was changed as shown in the following Table 1, and the protective layer 31 was not formed, and evaluation was performed in the same manner.

### Comparative Example 2

An ink jet recording material was produced in the same manner as in Example 1, except that in Example 1, the particles and the contents of particles in the coating liquid B for a protective layer were changed as shown in the following Table 1, and the ink accepting layer 21 was not formed, and evaluation was performed in the same manner.

### Comparative Example 3

The coating liquid A for an ink accepting layer of Example 1 was changed to the following coating liquid I for an ink accepting layer, and an ink accepting layer 21 was formed in the same manner as in Example 1 on one side of the PET support produced in Example 1. Next, a corona discharge treatment was performed under the condition of 310 J/m² on the PET support on a side opposite to the side having the ink accepting layer 21. Then, the particles and the contents of particles in the coating liquid C for a protective layer of Example 9 were changed, and a protective layer 31 was formed in the same manner as in Example 9 on the other side of the PET support on which the ink accepting layer 21 was formed. The coating liquid I for an ink accepting layer was prepared by mixing components in the following composition.

Next, the surface of the protective layer 31 formed in the above description was subjected to a corona discharge treatment under the condition of 200 J/m², and then the following coating liquid J for a protective layer was coated thereon by a bar coating method such that the dry film thickness was 0.5 μm. The coating liquid was dried for 1 minute at 160° C. to laminate a protective layer 33 on the protective layer 31. The coating liquid J for a protective layer was prepared by mixing components in the following composition.

In this manner, a decorative illumination ink jet recording material having a four-layer structure illustrated in the cross-sectional view of FIG. 3, that is, an ink jet recording material (a decorative illumination ink jet recording material having a four-layer configuration of ink accepting layer 21/resin base 11/protective layer 31/protective layer 33) having the ink accepting layer 21 on one surface of the PET support that was the resin base 11, and the protective layer 31 and the protective layer 33 on the other surface was produced.

Using the obtained ink jet recording material, evaluation was performed in the same manner as in Example 1.

<Composition of Coating Liquid I for Ink Accepting Layer>

Polyolefin (binder resin): 417.6 parts

(ARROWBASE (registered trademark) SE-1013N manufactured by UNITIKA LTD., solid content: 20 mass %)

Acrylic Resin (binder resin): 33.5 parts

(AS-563A manufactured by DAICEL FINECHEM LTD., solid content: 28 mass %)

Crosslinking Agent (carbodiimide-based compound): 52.1 parts

(CARBODILITE (registered trademark) V-02-L2 manufactured by Nisshinbo Holdings Inc., solid content: 40 mass %)

Catalyst: 7.3 parts

(manufactured by Nippon Chemical Industrial CO., LTD., 35 mass % solution of ammonium secondary phosphate for food additive)

Surfactant: 4.0 parts

(2 mass % solution of sodium 1,2-[bis(3,3,4,4,5,5,6,6,6-nonafluorohexylcarbonyl)]ethanesulfonate)

Distilled Water: The amount thereof was adjusted such that the total amount of the coating liquid I became 1,000 parts.

<Composition of Coating Liquid J for Protective Layer>

Acetic Acid Aqueous Solution: 402.0 parts

(manufactured by Daicel Corporation, 1 mass % aqueous solution of industrial acetic acid)

3-Glycidoxypropyltriethoxysilane: 110.0 parts

(KBE-403 manufactured by Shin-Etsu Chemical Co., Ltd.)

Tetraethoxysilane: 127.6 parts

(KBE-04 manufactured by Shin-Etsu Chemical Co., Ltd.)

Curing Agent: 1.3 parts

(ALUMINUM CHELATE A(W) manufactured by Kawaken Fine Chemicals Co., Ltd.)

Surfactant C: 14.7 parts

(manufactured by Sanyo Chemical Industries, Ltd., 10% aqueous solution of SANDEDDO (registered trademark) BL, anionic)

Surfactant A: 40.9 parts

(manufactured by Sanyo Chemical Industries, Ltd., 1 mass % aqueous solution of NAROACTY (registered trademark) CL-95, nonionic)

Distilled Water: The amount thereof was adjusted such that the total amount of the coating liquid J became 1,000 parts.

### Comparative Example 4

An ink jet recording material was produced in the same manner as in Example 1, except that regarding the coating liquid A for an ink accepting layer and the coating liquid B for a protective layer of Example 1, the particles and the contents of particles were changed as shown in the following Table 1, and evaluation was performed in the same manner.

TABLE 1

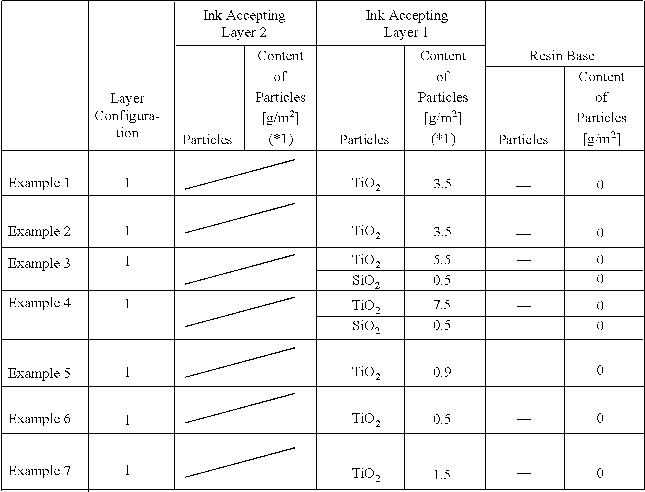

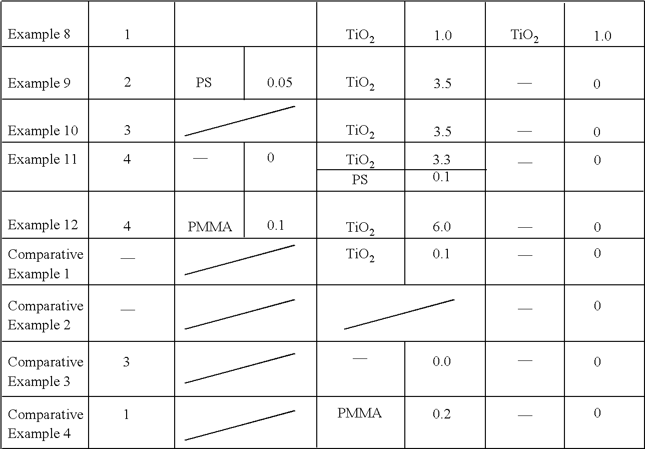

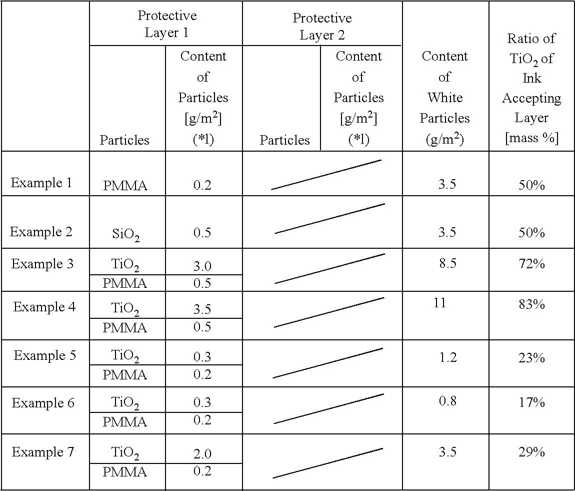

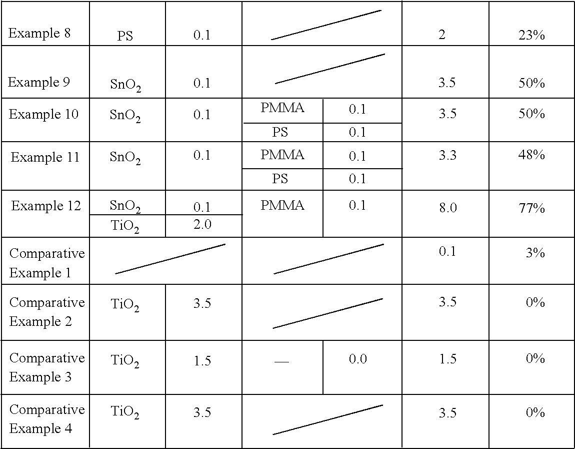

* In the table, the inclined line portion indicates that there is no layer itself. An example in which the content of particles is 0 g/m² indicates a layer that does not contain the particles.
(*1) The “Content of Particles” is the amount of particles applied in a case where the layer is formed by coating.

Details of the particles shown in the above Table 1 are as follows.

SiO₂ (transparent particles): Aqueous Dispersion of Silica

(SNOWTEX (registered trademark) MP-2040 manufactured by NISSAN CHEMICAL INDUSTRIES. LTD., solid content: 40 mass %)

SnO₂ (transparent particles): Aqueous Dispersion of Tin Dioxide-Antimony Composite Acicular Metal Oxide

(FS-10D manufactured by ISHIHARA SANGYO KAISHA, LTD., solid content: 20 mass %)

PS (transparent particles): Aqueous Dispersion Liquid of Polystyrene Latex

(Nipol UFN1008 manufactured by ZEON Corporation, solid content: 20 mass %).

TABLE 2

| | Diffuse | Image | Light Source | Ink |
|---|---|---|---|---|
| | Transmittance | Clearness | Image | Adhesion |
| Example 1 | A | A | B | B |
| Example 2 | A | A | B | B |
| Example 3 | B | A | A | B |
| Example 4 | C | A | A | B |
| Example 5 | B | A | C | A |
| Example 6 | C | A | C | A |
| Example 7 | A | B | B | A |
| Example 8 | B | B | A | A |
| Example 9 | A | A | B | A |
| Example 10 | A | A | A | B |
| Example 11 | A | A | A | A |
| Example 12 | B | A | A | A |
| Comparative | E | C | E | A |
| Example 1 | | | | |
| Comparative | A | D | D | E |
| Example 2 | | | | |
| Comparative | B | D | D | A |
| Example 3 | | | | |
| Comparative | B | D | C | A |
| Example 4 | | | | |

As shown in Table 2, in the examples, a clear image is obtained with any one of reflected light and transmitted light, and a light source image (lamp image)) that is easily shown in a case where transmitted light enters is unlikely to be visually confirmed, as compared to the comparative examples.

The disclosure of JP2014-157189A filed on Jul. 31, 2014, is, in its entirety, incorporated by reference in the present specification.

All of the documents, patent applications and technical standards mentioned in the present specification are incorporated by reference into the present specification to the same extent as if such individual document, patent application or technical standard was specifically and individually indicated to be incorporated by reference.

What is claimed is:

1. A decorative illumination ink jet recording material comprising:
a resin base;
an ink accepting layer that contains at least white particles and is disposed on one surface of the resin base; and
a protective layer that contains at least transparent particles and is disposed on the other surface of the resin base.

2. The decorative illumination ink jet recording material according to claim 1,
wherein the ink accepting layer comprises a first ink accepting layer and a second ink accepting layer in order from a side close to the resin base.

3. The decorative illumination ink jet recording material according to claim 2,
wherein among the first ink accepting layer and the second ink accepting layer, at least the first ink accepting layer contains white particles.

4. The decorative illumination ink jet recording material according to claim 3,
wherein among the first ink accepting layer and the second ink accepting layer, at least the second ink accepting layer contains transparent particles.

5. The decorative illumination ink jet recording material according to claim 1,
wherein the ink accepting layer further contains transparent particles.

6. The decorative illumination ink jet recording material according to claim 2,
wherein the first ink accepting layer further contains transparent particles.

7. The decorative illumination ink jet recording material according to claim 1,
wherein the protective layer comprises a first protective layer and a second protective layer in order from the side close to the resin base.

8. The decorative illumination ink jet recording material according to claim 7,
wherein among the first protective layer and the second protective layer, at least the first protective layer contains white particles, and at least the second protective layer contains transparent particles.

9. The decorative illumination ink jet recording material according to claim 1,
wherein the white particles include titanium dioxide.

10. The decorative illumination ink jet recording material according to claim 1,
wherein the transparent particles include particles of crosslinked polymethylmethacrylate.

11. The decorative illumination ink jet recording material according to claim 1,
wherein the content of the white particles is 1.0 g/m² to 10.0 g/m².

12. The decorative illumination ink jet recording material according to claim 1,
wherein the average primary particle diameter of the transparent particles is in a range of 0.1 μm to 1.5 μm.

13. A method of forming a decorative illumination image comprising:
discharging a radiation-curable ink composition to form an image by an ink jet method on the decorative illumination ink jet recording material according to claim 1; and
curing the radiation-curable ink composition by irradiating the discharged radiation-curable ink composition with radiation.

14. A decorative illumination image that is formed by the method of forming a decorative illumination image according to claim 13.

15. A decorative illumination signboard comprising:
a light source; and
the decorative illumination image according to claim 14.
